(19) United States
(12) Patent Application Publication
(10) Pub. No.: US 2025/0293998 A1
(43) Pub. Date: Sep. 18, 2025

(54) MAINTAINING AND RESTORING CONTEXT FOR ARTIFICIAL INTELLIGENCE CHATBOTS

(71) Applicant: MicroStrategy Incorporated, Vienna, VA (US)

(72) Inventors: Jeffrey Clay Courcelle, Atkinson, NH (US); Ananya Ojha, Dunn Loring, VA (US); Tingting Jin, Hangzhou (CN); Yufan Shi, Hangzhou (CN); Lan Ao, Hangzhou (CN); Shushu Xu, Hangzhou (CN)

(21) Appl. No.: 19/224,010

(22) Filed: May 30, 2025

Related U.S. Application Data
(63) Continuation-in-part of application No. 18/596,738, filed on Mar. 6, 2024.
(60) Provisional application No. 63/653,982, filed on May 30, 2024.

(51) Int. Cl. H04L 51/02; H04L 51/216

(52) U.S. Cl. CPC H04L 51/02; H04L 51/216

(57) ABSTRACT

Methods, systems, and apparatus, including computer programs encoded on computer-storage media, for maintaining and restoring context for artificial intelligence chatbots. In some implementations, a system receives a user prompt from a user through a chatbot interface, and the system provides a chatbot response to the user prompt through the chatbot interface. The system provides a control that is associated with the chatbot response on the chatbot interface and is selectable by the user to cause the chatbot response to be saved. In response to user selection with the control, the system saves the chatbot response and corresponding metadata that includes context information used by the one or more AI/ML models to generate the chatbot response. The chatbot interface is configured to display the saved chatbot response a and answer a subsequent user prompt using the context information in the metadata corresponding to the saved chatbot response.

### BACKGROUND

This application is a continuation-in-part (CIP) of U.S. patent application Ser. No. 18/596,738, filed on Mar. 6, 2024, and this application claims the benefit of priority to U.S. Provisional Patent Application No. 63/653,982, filed on May 30, 2024, and the entire contents of the previous applications are hereby incorporated by reference herein.

### BACKGROUND

Artificial intelligence (AI) and machine learning (ML) techniques have improved significantly and continue to gain new capabilities. For example, neural network models, such as large language models, have shown the capability to process and to generate many types of natural language text. For example, chatbots that leverage large language models can respond to user prompts (e.g., user inputs such as questions) in text-based messaging sessions or conversations with users.

### SUMMARY

In some implementations, a computer system provides users access to artificial intelligence or machine learning (AI/ML) chatbots, which can respond to user prompts with text, visualizations, and other content. The system can use various features to generate and store representations of the context of conversations between a user and a chatbot. For example, when a chatbot response or visualization is generated, the system can generate and store associated metadata that preserves important aspects of the context used to generate the response or visualization. This stored metadata can then provide context to inform later prompts that ask follow-up questions or ask about the content of a previous response, even in a different session or after the current conversation has moved on to other topics.

In many cases, users interact with a chatbot over a series of multiple interactions, gradually narrowing to a particular topic over the course of multiple prompts and responses. As a result, the response from a chatbot is often based not only on the immediately preceding user prompt, but also on earlier user prompts and chatbot responses in the conversation.

The system can provide users features that enable the user to select chatbot responses or visualizations output by the chatbot to be saved or exported for later use. For example, a user can click a button to save a “snapshot” of a chatbot response to preserve the chatbot response and its context. The system associates the snapshot with metadata that can store relevant context used to generate that response, such as the previous user prompt, interpretations used by an AI/ML model, code or instructions for data retrieval (e.g., structured query language (SQL)) statements generated by an AI/ML model or used by the chatbot, mappings of keywords or topics to data sets and data objects, topics or keywords associated with the prompt and response, and so on.

The metadata that the system associates with chatbot response snapshots and visualizations can include information selected from multiple previous interactions with the chatbot, and not only from the user prompt occurring just before the output of the chatbot. For example, a user may develop or reach a topic over several interactions, with separate prompts being used to incrementally find a data set of interest, then ask about a particular time range, then ask further about a particular geographical region of interest, before finally asking the chatbot, “show me a chart of this data.” In this example, the series of prior user prompts, and the corresponding chatbot responses that the user views and asks about, all contribute to the ultimate meaning of the phrase “this data” in last prompt. Because the interpretation is built up over multiple interactions, the system can use information from the series of multiple interaction to interpret and respond to the last prompt as well as metadata for a response or visualization responding to that prompt. As a result, the metadata for a snapshot or visualization can include information from several prior prompts and responses in the conversation, or portions or topics extracted from them.

The metadata associated with a snapshot or visualization can preserve the relevant context corresponding to the point in the conversation when the chatbot response or visualization was generated. This way, even if the conversation later moves on to different topics or if the conversation is ended and discarded, the stored metadata can preserve the topics, interpretations, and context allowing the system to respond to questions about the snapshot or visualization. With this information, the chatbot can reuse the same interpretations and data sets used before, which improves consistency in the output of the chatbot across multiple questions and multiple sessions of use. This can be important to a user who may later submit follow-up questions asking about the topics and data in the snapshot or visualization. When a snapshot or visualization is selected by a user, the system can interpret subsequent user prompts based on the metadata for the selected snapshot or visualization, thus continuing the interpretations and context used earlier. In this way, the snapshot or visualization, with its associated metadata, provides an entry point for the chatbot to effectively answer follow-up questions about the information in a snapshot or visualization, even if the previous conversation has ended or is unavailable.

In addition, if one user shares the snapshot or visualization with a recipient, the metadata is also provided, which enables the system to use the metadata to appropriately respond to questions from the recipient. For example, using the metadata received with the snapshot or visualization, the chatbot can respond to questions about the snapshot, the visualization, or the underlying information, using an interpretation consistent with the one originally used to generate the snapshot or visualization.

In some implementations, the system uses an AI/ML model to generate at least some of the metadata stored with the snapshot or visualization. For example, the system can ask an AI/ML model to summarize the conversation history to provide a statement describing the information from the conversation history that is relevant to the most recent prompt and/or chatbot response. In this way, the system can leverage the natural language processing ability of the AI/ML model to identify and assemble the portions of the conversation history that were relied on or which resulted in the interpretations used. As another example, the system can ask an AI/ML model to generate a title or heading that describes the visualization or snapshot. In many cases, a prompt may not be fully descriptive of even what is being asked of the chatbot, especially for short user prompts having pronouns that refer to previous portions of a conversation. An AI/ML model can generate a more complete title or one-sentence summary that combines information from a series of multiple interactions of the user with the chatbot.

In some implementations, the metadata can include some or all of the conversation history that precedes the generation of a chatbot response, e.g., a snapshot or visualization. While the full conversation history may be helpful at times, the full conversation history can at times be excessive (e.g., providing unnecessary information and unnecessarily increasing processing utilization) or can be insufficient (e.g., lacking information about the interpretations made by the chatbot and mappings to data sources and data objects). As a result, the system can generate and store metadata that is different from the conversation history and still can provide information spanning multiple user-chatbot interactions.

For example, the system can examine the conversation history (e.g., a series of user prompts and chatbot responses) to identify relevant items to include as metadata for a snapshot or visualization. The system can then include a subset of the conversation history that the system determines to be relevant to a particular chatbot response, including potentially some or all of one or more previous prompts and responses before the prompt that the particular chatbot response responds to. The entire conversation history for a chatbot session may include many types of information that are not relevant to the current prompt and interpretation used to generate a snapshot or visualization. Providing portions that are not relevant may reduce the accuracy of chatbot in answering about a particular snapshot or visualization, and providing unnecessary history information as context for follow-up questions can increase power consumption, processing requirements for response, and cost of generating the chatbot response. Thus, by analyzing the conversation history (and/or intermediate information used by a chatbot in answering a prompt) and extracting relevant portions, the system can provide a context that is accurately customized for or targeted to the particular chatbot response, even if that context was built over multiple prior interactions. By selectively including portions of the conversation history, rather than simply including the entire history, the system can achieve more efficient storage utilization. In addition, the system can achieve more efficient utilization of processing capacity, because larger amounts of context often result in greater power usage and higher computational requirements for inference processing with many LLMs.

In some implementations, the metadata includes a subset of previous interactions (e.g., previous user prompts in a chatbot conversation) that the system determines to be relevant to the content or generation process of a chatbot response. The system can include keywords, topics, or categories identified by the system as relating to a chatbot response or its underlying data (e.g., retrieved data, potentially obtained using a SQL statement generated by an AI/ML model). As discussed above, the system can include in the metadata a summary that the AI/ML model generated.

The system can also include in the metadata intermediate information taken from within multi-step interactions with an AI/ML model to generate a chatbot response. For example, as one step of answering a prompt, the system can use an AI/ML model to generate a SQL statement or other code or instructions to retrieve or process data from a data set. The system can then provide the results from the data set in another interaction with the AI/ML model (or another AI/ML model) to generate chatbot output for the user. The system can include in the metadata the code or instructions for data processing (e.g., SQL statement). The code or instructions can be an expression of or representation of the interpretations made by the AI/ML model in processing the user prompt, and can also provide the ability to run the code or instructions again to gain a refreshed response using the same interpretations.

In some implementations, the system analyzes code or instructions generated by the AI/ML model to extract or identify interpretations of terms and mappings between terms or concepts to data sets and data objects. The metadata can include those interpretations or mappings in addition to or instead of the code or instructions themselves. In many cases, the chatbot conversation history alone (e.g., prior user prompts and chatbot responses) do not state or indicate the interpretations and data mappings used to generate a chatbot response. The system can improve consistency and accuracy by including in the metadata for a snapshot or visualization the code or instructions for data processing, or other information indicating the interpretations or mappings of terms and phrases to data sets, data objects, etc.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a diagram showing an example of a system for providing access to artificial intelligence or machine learning chatbots.

FIGS. 2A-2C are diagrams that show examples of user interfaces for interacting with chatbots, including features to save responses and context information for later use.

FIGS. 3-5 are diagrams showing additional examples of user interfaces for interacting with a chatbot.

FIGS. 6A-6B are diagrams showing examples of user interfaces showing snapshots from chatbot responses to user prompts and subscriptions to provide updated or refreshed responses to the user prompts over time.

Like reference numbers and designations in the various drawings indicate like elements.

### DETAILED DESCRIPTION

In some implementations, a computer system provides functionality for creating and distributing customized interactive applications, such as chatbots, that provide responses using artificial intelligence or machine learning (AI/ML) models, such as large language models (LLMs). The system can include features that preserve the interpretations made by chatbots and associate them with chatbot responses, so the same interpretations and data used to create one response can be carried over to create a follow-up question. In this way, the system can associate relevant information data sets, data objects, filter criteria applied, data aggregations performed, and so on to maintain the use of the same interpretations in responding to later question. In addition, even when the follow-up question is not directly asking about the previous result or data, the stored information can still be used to disambiguate pronouns or other references and to orient the response to focus on the data sets, data objects, and topics that correspond to the previous result.

In many cases, users conduct step-by-step analysis through multiple interactions with a chatbot. Sometimes users arrive at a subset of data results, which may be from the current chatbot conversation or a previous chatbot conversation, and then they would like to perform further analysis or ask follow-up questions about that conversation result.

The system can enable chatbots to accurately answer follow-up questions about a data set by generating and storing metadata that is embedded or otherwise associated with a chatbot response. Then, when a user later interacts with the chatbot response content or visualization, even if outside the previous chatbot conversation, the system can reuse the same interpretations and relevant context to perform further analytics, such as by answering follow-up questions. This enables the system to answer accurately and consistently about chatbot responses, even if asked after the previous session has ended, has been deleted, or is otherwise unavailable. By generating and storing metadata with the relevant context and interpretations for a chatbot response or visualization, the system is prepared to efficiently resume and extend data analysis even if requested after a different chatbot conversation, or through a different interface, or by a different user.

These features can also streamline the data analysis process, reducing time and effort required for data exploration and decision-making by allowing users to build upon previous analyses without starting from scratch. In addition, the features can provide a more natural conversation experience and reduce frustration of users, who otherwise may feel that a chatbot provides inconsistent or unreliable answers or does not always follow the user's instructions.

As discussed further below, the system can enhance the conversational experience by providing continuity and consistency of chatbot interpretations and data sets, even though there is discontinuity or interruption between different analysis steps or user requests (e.g., after a conversation has changed topic, when a different user asks about a snapshot or visualization, etc.). For many users, an ad-hoc data processing analysis might not be done in one complex compound question. While the user explores the data through a series of questions, sometimes the user wants to reuse a previous result as an input for the next question. For example, a user may ask, “What is my forecasted sales for the next three quarters?” Once the user has the answer and sees from the results in the chatbot response indicating that quarter Q3 would have the highest predicted sales, the user may ask a question about the sales percentage change between 2023 Q3 and 2024 Q3. The chatbot should be able to use the forecasted sales number from the previous chatbot response (e.g., as expressed in text and/or visualization content) and obtain the number from 2023 Q3 and calculate the percentage difference.

The system can use various techniques to achieve consistency across multiple interactions. For answering further questions within a chatbot conversation, as the user continues to ask new questions, the system can use the context of the previous response and previous question to answer the next question. Beyond simply using the conversation context, the system can store and use additional information, such as intermediate content or data sets that was generated in the process of arriving at a chatbot response, but which is not included in the chatbot response. For example, although a chatbot response may show the top 5 items according to a metric, as requested by the user, there are often intermediate items generated such as a filtered or ranked result set that includes identifiers and metric values for more than just the top 5 items. In addition, the intermediate information can include a SQL statement used to generate the result set or a representation of the interpretations used in the SQL statement. To answer the next question, the system can provide the intermediate information (e.g., SQL statement, extracted interpretations, result data, etc.) used in generating the previous response as input to an AI/ML model (e.g., as part of the context for an LLM), with a label or other designation to indicate the prompt or response that it corresponds to. As a result, the processing of the chatbot can provide consistency or data and interpretations used, from one answer to the next, by reusing the intermediate results or intermediate content that produces a chatbot response, in addition to or instead of the conversation history.

The system can generate and store metadata that includes relevant portions of the conversation history and intermediate content used to generate a chatbot response, allowing consistency and reliability in interpretations even when the user's question is not the immediately subsequent query. In some implementations, the system generates and saves this metadata for each chatbot response or visualization generated. As a result, each chatbot response or visualization can have an associated or embedded set of metadata that the system can use to tailor interpretations to the appropriate topics, data sets, data objects (e.g., metrics, attributes, etc.), filter criteria, data aggregations, and so on. As a result, from any prior chatbot response or visualization that a user selects, the system restore or reuse the relevant context, including the interpretations of terms (e.g., whether “profit” refers to “gross profit” or “net profit”) and data mappings (e.g., “profit” is mapped to values in particular column of a particular data set).

The system can use these techniques to provide consistency for chatbot conversations provided through messaging platforms and other interfaces. For example, in a messaging application, a user can ask a question by sending a message to a chatbot, and the chatbot provides a response message, which can include a text answer and a visualization. The data representation of the response message can include embedded metadata that specifies the interpretations, data mappings, SQL used, data values, or other context that led to that response. This facilitates the consistency of interpretations across a series of questions from the user. For example, the user may ask “Which five regions have the highest profit for product ABC?” Once the answer including a list of these five regions is displayed, the user can immediately ask a follow-up question, and the chatbot can use the information from the previous response (including potential intermediate information or information derived from multiple prior interactions) to inform the creation of the next response.

Similarly, if a previous chatbot interaction (e.g., user question and chatbot response) occurred a few days ago, the user can identify the message with the chatbot response of interest, and click “reply” to ask another follow-up question, such as “For these five regions, which product has the highest profit margin?” In this case, the system uses the metadata for the chatbot response in the selected message (e.g., showing the five regions with highest profit) to provide a data filter for answering the follow-up question (e.g., asking about highest profit margin). In this case, the amount of time that has elapsed since the earlier question or the fact that the conversation may have continued on to different topics does not impede the consistent interpretation of the follow-up question. Based on the user's selection of the prior chatbot response message, the system extracts the metadata, potentially including interpretations, data mappings, SQL statements, or other context, to tailor the chatbot processing to the particular set of data discussed in the prior chatbot response message. In addition, the embedded metadata can remain with the chatbot response when the user shares, forwards, exports, or saves the response content or the visualization. As a result, even if a recipient has the response content or visualization without the surrounding conversation history, the system can still import and use consistent interpretations for follow-up questions based on the embedded metadata.

In some implementations, the system is configured to detect when a follow-up question refers to the data set or content from a previous chatbot interaction, and the system automatically applies the same interpretations, mappings to data objects, and result data set, even if the user did not explicitly designate the previous chatbot response as a snapshot. In a subsequent user prompt, the text reference to the same type of data or to topics of the previous chatbot response can be sufficient for the system to detect that user is asking about the same information, and thus that the previous result data and interpretations should be maintained. The follow-up question does not need to be the interaction immediately after the relevant prior question. For example, a user may ask about a topic (e.g., “Which five regions have the highest profit for product ABC?”), receive an answer, and then provide one or more prompts before referring again to the same topic (e.g., “Which of the five regions has the most stores?”). The system can compare the content of the new user prompt and prior user prompts and chatbot answers (e.g., comparing keywords or phrases, comparing similarity of vector embeddings, or by other techniques) to detect references to a particular prior result data set or topic. In response to detecting the reference to the previous topic, the system can apply a data filter, determined based on the identified previous chatbot response, to limit the scope of data used to answer the new user prompt, so that the same interpretations and data are used consistently for the topic.

For example, in some cases a chatbot response includes a list of results or includes a visualization representing results. During the conversation, the system can automatically store (e.g., cache) the metadata for the chatbot responses, in the same that data would be stored when a user selects to save a chatbot response as a snapshot. The saved metadata for each chatbot response can specify the interpretations of terms, the data sources used, the mappings of terms or concepts to specific data objects, the code or instructions for data retrieval and data processing, and the specific result data used to determine the results or visualization. Then, when the user asks a follow-up question (e.g., one that the system detects is relevant to or that references topics of the previous question or its chatbot response), the system applies filters based on the stored metadata for the previous question, to ensure continuity is maintained.

For example, if the answer to a previous question was a list of 10 locations, and a follow-up question is determined to ask about those 10 locations, the system provides the new question to the AI/ML model with (1) the result data set (and potentially other metadata or context for the prior question) that specifies those 10 locations and (2) an instruction to the AI/ML model that the new question should be answered based on the results from the previous result data set. This effectively adds a filter to the user's question (e.g., limiting the scope of the chatbot response to the 10 locations determined from the prior question), which helps ensure that the answer will be relevant and consistent with the existing information in the conversation.

As another example, a chatbot answer may include a data visualization (e.g., a chart, a graph, a map, etc.), and a later question in the conversation may refer to the visualization or to the data in the visualization. The system then interacts with the AI/ML model to apply a data filter based on the data in the visualization. For example, the question can be answered based on the values or data series of the visualization, or based on the interpretations or data object mappings used to generate the visualization. This allows the previous visualization and its data to be reused to answer the later question about the same topic, ensuring consistency through the conversation.

In general, a previous chatbot answer, or a visualization from a previous chatbot answer, can be used as a filter or as an analytical data input for answering a later question, in response to determining that the later question is related to or references the same topic. This provides contextual memory and continuity in the data used and interpretations used through a conversation, or even later (e.g., if a user asks about an item in a snapshot). The system can maintain context across a series of questions to allow follow-up queries to leverage previous results without needing to redefine the context. The system can cache the previous visualization result (e.g., the interpretations, settings, result data, etc.) and reuse it for later questions.

The system can use these techniques for metric calculation and customization. For example, the system can facilitate the automatic definition and calculation of derived metrics (e.g., a metric that incorporates filters or criteria that may be defined based on a series of different user questions). For example, a user may ask, “I will be focusing on product ABC, how many more units do I need to sell in Q3 to achieve this predicted sales number?” The system can generate a new metric based on this request that takes the previous sales number from an earlier question and then divides the sales number by the unit price for product ABC.

The previous chatbot response or data visualization, and corresponding metadata, can be used as data input to construct data filters that are provided to AI/ML models to guide the answers of AI/ML models (e.g., through instructions), and/or are used to filter the actual result data generated by a data processing system (e.g., filters applied by a database system providing results for an AI/ML model to use in answering a user's question).

These techniques can enhance the compatibility of user interpretations. Because the new question is based on the result data generated for the response to a previous question, the system can indicate this to the user and describe the interpretations used, including the reference to the previous chatbot response.

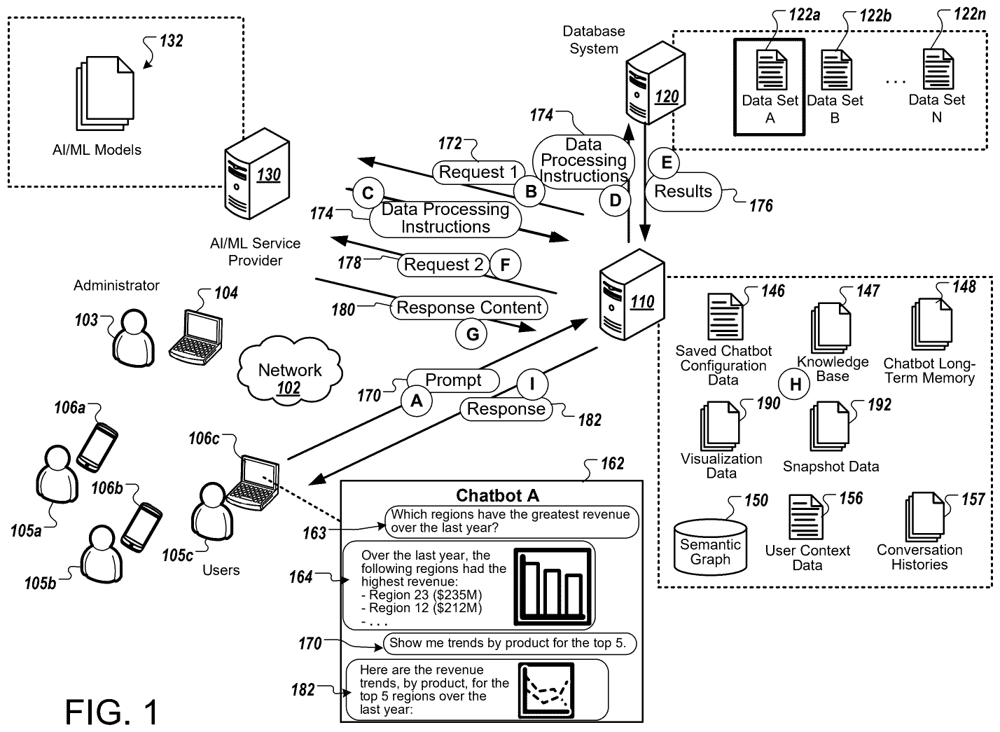

FIG. 1 is a diagram showing an example of a system for providing access to AI/ML chatbots. The system 100 includes a computer system 110, a database system 120, and a AI/ML service provider 130. The elements of the system 100 communicate over a network 102, which can include public and/or private networks (e.g., wide area network, local area network, etc.) and can include the Internet. The computer system 110 provides access to the chatbots to client devices 106a-106c of users 105a-105c, and the computer system 110 coordinates processing to generate and provide answers to questions and other user prompts that users submit to the chatbots.

The example of FIG. 1 includes stages (A) to (I), which represent various operations and a flow of data, and which can occur in the order illustrated or in a different order. These stages show an example where a user 105c has previously used a chatbot interface 162 to submit a user prompt 163 and receive a chatbot response 164. The user 105c then submits another user prompt 170 related to the previous question, and the computer system 110 coordinates the processing to generate a response 182 from the chatbot.

The computer system 110 can be implemented using one or more servers, including one or more cloud computing systems. For example, the computer system 110 can be an application server. The computer system 110 provides front-end functionality to interface with various client devices. For example, the computer system 110 can provide an interface for creating and editing chatbots and other interactive applications that leverage AI/ML models. The interface can be an application programming interface (API), a user interface (e.g., by providing user interface data for a web page or web application), or another type of interface. As discussed further below, the computer system 110 performs various other functions to generate and save chatbots, to manage and grant access to existing chatbots, and to coordinate the processing of user prompts to generate responses from the chatbots.

The database system 120 can provide various data retrieval and processing functions. For example, the database system 120 can be a database management system (DBMS), and can include the capability to process operations specified in structured query language (SQL), Python code, or in other forms. The database system 120 has access to various datasets 122a-122n, which can be private datasets for organization, such as a company. The database system 120 can store and use datasets in any of various forms such as tables, data cubes, or other forms.

The AI/ML service provider 130 can be a server system or cloud computing platform that provides access to one or more AI/ML models 132, such as LLMs. The computer system 110, the database system 120, and the AI/ML service provider 130 may be implemented as separate systems or may be integrated in a single system. For example, the AI/ML service provider 130 can be a third-party service or can be managed and operated by the same party as the computer system 110 and/or the database system 120.

The chatbot can be one that is customized by an administrator 103, who can specify the features and behavior that are desired for the chatbot. Through a series interactions, the administrator 103 can specify characteristics such as which dataset(s) 122a-122n the chatbot will use to generate responses, the appearance and style of the chatbot interface, whether the chatbot can access data from the Internet or other sources, access control settings, and so on. The computer system 110 saves the settings specified by the administrator and creates a new chatbot. To provide the interface for creating or editing chatbots, the computer system 110 can provide data for a web application, web page, or native application that, when rendered on a client device, provides the functionality to specify settings of the chatbot being created or edited. As a result, the chatbot can be more than simply an AI/ML model 132, such as a LLM, and includes other processing capabilities such as retrieval of data from data sets, customized behavior and settings set by the administrator 103, customized visualization generation capabilities provided by the computer system 110, and so on.

The computer system 110 uses the chatbot settings from the administrator 103 to generate and save the data and settings that define the chatbot. In the example, this is shown as saved chatbot configuration data 146. For example, the computer system 110 can create a record or series of records representing the new chatbot and its customized settings. For each chatbot, the computer system 110 saves a separate set of records or definitions that specify the characteristics and customizations of that chatbot. For example, each chatbot can have a set of saved chatbot configuration data 146 that specifies, among other items, the name of the chatbot, the dataset for the chatbot, a selection of which AI/ML models 132 to use for the chatbot, the appearance and formatting characteristics of the chatbot, access control information for the chatbot, customized instructions to append to or include in user prompts to AI/ML models, and so on.

The computer system 110 can include a number of modules and datasets that facilitate the generation of new chatbots. For example, the computer system 110 can include a set of default chatbot settings that provides a default or base configuration for new chatbots. The customizations specified in the received chatbot settings can override or replace settings in the default set of chatbot settings to form the final set of saved chatbot configuration data 146.

Generating and saving the chatbot can include registering the chatbot with a number of different applications, web pages, web applications, or other services. For example, the computer system 110 can register the new chatbot, with its name, capabilities, and applicable context, so that the option for the chatbot appears for users who have been granted access. For example, the chatbot can be made available through the document libraries of users who are approved to access the chatbot.

In some implementations, the computer system 110 enables the administrator to attach one or more additional data sets to adjust the operation and output of the chatbot. For example, an additional data set can be a knowledge base 147 or data dictionary can be added. Unlike the primary data set that the user selects for the chatbot (e.g., data set 122a), the chatbot is not configured to answer questions about the additional data set or to retrieve metrics or to provide visualizations of the knowledge base 147. Instead, the knowledge base 147 can be provided to assist the chatbot in interpreting user queries and providing responses with the terminology for the user's organization. In general, the knowledge base 147 can function to provide contextual knowledge to the AI/ML models 132, so the models can classify and use the nomenclature of the end user when generating answers to user prompts.

Many different organizations or departments use terms that have a special contextual meaning, or are not part of general language, and so would not be available for training of an LLM. For example, a company may internally use various names for its products, projects, teams, locations, policies, initiatives, organizational structure, and so on. For example, a company be developing a product with a codename of “starfish” that being developed by a group of employees called “red team.” The training state of an LLM would not incorporate information about these entities, which are specific to the company and not referenced in public documents. To enable the chatbot to process questions about these internal entities and provide answers that reference them, a knowledge base 147 is designated for the chatbot to describe these and other internal terms. Each time the user submits a prompt, the knowledge base 147 can be provided to assist the LLM with the context that is appropriate for the company. The knowledge base 147 can provide information similar to a semantic graph, by describing entities and their relationships. In some cases, the information in the knowledge base 147 can be derived from a semantic graph 150 and then converted into text (e.g., unstructured, semi-structured, or structured) in a format that can be processed by the LLM.

In general, the knowledge base 147 or other additional data set can include data that maps terms or phrases to their meanings. In many cases, this can include semi-structured data or explanatory content, as a way to explain entities and relationships wo the AI/ML models 132. Although the knowledge base 147 may include definitions, more generally the information may include descriptions of people, roles, business units, products, and other terms that may be referenced. The administrator may upload one or more of additional data sets and specify which additional data sets, if any, should be used to provided context for a chatbot. The data sets selected for this contextual function can then be used to provide context for all prompts and responses of the chatbot.

In some implementations, the contextual data sets or knowledge bases can be applied so that they apply to multiple chatbots. For example, an enterprise can designate one or more knowledge bases 147 as contextual data sets that can be applied consistently across the enterprise, for all chatbots created and used in the enterprise. Similarly, different departments within the enterprise may add their own particular contextual data sets that may supplement the enterprise-wide knowledge bases 147. In addition, specific contextual data sets can be added for specific chatbots. In this way, chatbots at different levels of an organization can inherit a consistent set of terminology and knowledge in an organization, which also makes maintaining the overall knowledge base much more simple. The knowledge bases 147 can additionally or alternatively be specified with a scope that corresponds to a computing environment, so that chatbots associated with a particular domain or server inherit the knowledge bases for that domain or server.

One of the advantages of the knowledge base 147 is consistency for many users and even for many different chatbots of an organization. The user submitting a prompt does not need to take any action to select or include the knowledge base 147 in the chatbot's processing, the chatbot automatically include the knowledge base 147 in its context for each prompt or question received. Also, because the knowledge base 147 can be shared or inherited by many chatbots within an organization, updating and maintaining the knowledge base 147 is simple. An edit to the knowledge base 147 is automatically applied to all of the chatbots associated with the organization, even if the chatbots were created by different administrators or provided to different sets of users.

In addition, the knowledge base 147 provides persistent context that is not lost from one prompt to another or from one session to another. The knowledge base content can also be implemented applied in a manner that the knowledge base 147 does not count toward the instruction token limits that the AI/ML models 132 consume for each response. Rather than counting toward the tokens for prompts and recent history, the knowledge base 147 can be accessed or provided to the AI/ML models 132 as a separate source of knowledge apart from the prompt and context, and so does not count toward the token limits of an LLM. Implementations of access to the knowledge base 147 can vary. For example, when a session with the chatbot is instantiated, the knowledge base can be provided as part of initializing the chatbot. In some cases, the AI/ML models 132 are additionally or alternatively configured to access the primary dataset and if the user prompt includes a term or makes a request for an item not specified in the primary dataset, the chatbot is configured for the AI/ML models 132 to then check the knowledge base or other contextual data sets. In some implementations, the knowledge base 147 can be prepared as an embedding, a vector database, or other format that can be accessed by or referred to by the AI/ML models 132.

With the additional knowledge base 147, the chatbot has three general sources of information before even receiving the user prompt. First, the chatbot has the primary dataset (e.g., data set A 122a) selected by the administrator, which is the primary source of answer for the chatbot. Second, the chatbot has a set of instructions that the administrator provided, e.g., general instructions such as the description of the primary dataset, the purpose of the chatbot, the type of user or type of task interacting with the chatbot, and a description of how the chatbot should form responses (e.g., response format, types of data to include, order of elements to include, etc.). Third, the chatbot has the knowledge base 147, which provides additional context behind the purpose of the bot and how the customer defines things. These types of information form a base level of information that is available for all users that use the chatbot. Also, for each user, the chatbot receives the user's prompt and also receives information about the conversation history of the user (e.g., previous queries and responses, from the current session and/or prior sessions).

In some implementations, the chatbot is designed to have a long-term memory 148, which can store information learned from users in past interactions. For example, LLMs and other AI/ML models 132, on their own, are generally stateless and do not natively understand the user context or history of interactions with the user, especially from previous sessions. The computer system 110 can facilitate learning by the chatbot to provide infrastructure that creates a long-term memory 148 for the chatbot. For example, the long-term memory 148 can store items such as definitions of terms for a particular user context, unique text elements the chatbot might encounter, and feedback from prior user interactions.

One valuable aspect of the long-term memory 148 is the ability for the chatbot to learn and adapt from explicit or implicit user feedback over time. If a user asks questions, then gives feedback they were expecting something different (e.g., either through text of a prompt to the chatbot or through an external survey or rating), then the computer system 110 can capture that feedback and update the chatbot to better provide what the user intended in the future. For example, the computer system 110 may add or adjust the instructions to the chatbot to reflect the user expectations or preferences. In some cases, this may include changing the default response format or response instructions, or may include adding rules or explanations that are context-dependent (e.g., apply to specific phrases or prompt types). This learning may occur at different levels. For example, it may include learning that particular terms, phrases, or combinations of terms call for a particular type of response. As another example, the feedback may more shift answers generally in certain ways, e.g., to be more verbose, more concise, to add or change visualizations, to change the order of content, to add or adjust summary elements, and so on.

The learning of the chatbot is managed by the computer system 110 and happens on an ongoing basis as users interact with the chatbot. The information learned is stored outside the LLM or other AI/ML models 132, and is stored in the long-term memory 148 designated for the chatbot. Each chatbot that is created can have its own long-term memory 148, which is updated by the interactions of its own users. Before the computer system 110 asks the stateless LLM to provide a response to a user prompt, the computer system 110 facilitates retrieval of data from the long-term memory 148, potentially to provide customized instructions or additional contextual data to accompany the user prompt and tailor the response based on what has been learned from prior interactions. The long-term memory 148 thus provides better reference data for LLM to use in guiding answer generation.

The long-term memory 148 can include business definitions of other users have specified or uploaded. In this way, the long-term memory 148 can supplement or expand on the descriptions provided in the knowledge base 147. The chatbots can be configured to learn at different levels, e.g., at the level of individual users, at the level of a department or group of users, and for an enterprise as a whole. In other words, the preferences of an individual may be learned and applied for that individual. In addition, the aggregate preferences learned for many individuals can be combined to also adjust the chatbot, to accelerate the adaptation of the chatbot to meet the needs of the user base. In some implementations, the computer system 110 can use access control lists and permissions for users to apply security policies to adjust access and appropriately set the context for each user.

The example of FIG. 1 shows the computer system 110 providing access to the chatbot to various users 105a-105c. For example, the chatbot settings specified by the administrator can specify access control parameters that indicate groups of users or individual users or categories of users who receive access to the chatbot. The computer system 110 provides access to the chatbot to authorized users in any of various ways. For example, the computer system 110 can send a message to authorize users with a URL or other link to web page, web application, or native application functionality providing the chatbot interface. As another example, the computer system 110 can update and interface such as a document library, dashboard, or other user interface to include a panel with the chatbot interface, or to include an icon, button, or other control that is interactive so that users can interact to request that the chatbot interface be provided.

In the example of FIG. 1, the user 105c previously submitted the user prompt 163, “Which regions have the greatest revenue over the last year?” The computer system 110 received this prompt 163, and answered by performing a series of actions, for example: (1) instructing an AI/ML model 132 generate code or instructions (e.g., an SQL statement) configured to cause a data storage system to retrieve or generate results for answering the prompt 163; (2) interacting with the database system 120 to use the AI/ML-generated code or instructions to obtain the results from a data set 122a; and (3) provide the results to an AI/ML model 132 that generates content of the chatbot response 164. The computer system 110 may also generate visualization data for a visualization in the chatbot response 164, based on the results from the data set 122a.

When the computer system 110 generates the chatbot response 164, the computer system 110 saves metadata associated with the chatbot response 164, where the metadata includes information about the interpretations made and filtered data used in making the chatbot response 164. For example, the metadata can include the AI/ML-generated code or instructions, a mapping of terms or concepts to portions of the data set 122a, data aggregations, data filtering criteria used, and so on. As a result, the metadata can include information separate from and different from the conversation history, e.g., information in addition to or different from the prompt 163 and chatbot response 164 that make up the conversation history at this point. In particular, the metadata can preserve or define aspects of the data set discussed in context of the chatbot response 164, so that the chatbot can respond to further questions or user prompts that follow the chatbot response 164 (or relate to the same data) with high accuracy and consistency of interpretating the user statements.

In stage (A), the user 105c interacts with the chatbot by submitting the user prompt 170, such as a natural language question or statement. The user interface 162 includes a field in which the user can enter a question or other user prompt 170. In the example, the user 105c enters the prompt 170, and the user's client device 106c sends the prompt 170 to the computer system 110 for processing. The computer system 110 receives the prompt 170 and begins a series of interactions used to generate the response to the prompt 170.

As discussed above, the chatbot has an associated knowledge base 147 that can include, for example, descriptions of terms that may have a unique meaning in the particular context of the user. The knowledge base 147 may be shared by multiple chatbots or even all chatbots associated with the company or organization of the user. When the computer system 110 establishes a new session of the chatbot and a user, the computer system 110 can provide the knowledge base 147 as part of initializing the session with the AI/ML model 132. As a result, the knowledge base 147 can provide additional context for all of the subsequent interactions with the AI/ML model 132.

In addition, the chatbot has information in its long-term memory 148 that has been learned through previous interactions with the user 105c and potentially various other users. This information can be provided upon initialization of the chatbot, as the knowledge base 147 is, or can be provided in other ways. For example, the information from the long-term memory 148 can be selectively and contextually applied, as the computer system 110 analyzes the prompt 170 and determines whether there is information in the long-term memory 148 that is relevant to the content of the prompt 170. The retrieved content of the long-term memory 148 that the computer-system 148 determined to be relevant to the prompt, can then be provided with the prompt 170. As another example, certain information in the long-term memory 148 may be applicable to a specific user, role, or permission level, and the computer system 110 can provide that information in response to determining that the user 105c submitting the prompt 170 is that user or has that role or permission level. In other cases, the information in the long-term memory 148 supplements or alters the general instructions or initialization commands for starting the chatbot session, either in all cases or selectively when specific prompt content or user context is detected.

In stage (B), the computer system 110 generates and sends a first request 172 to the AI/ML service provider 130. The first request 172 includes the prompt 170 and information about the dataset 122a (e.g., the data set that the chatbot is configured to use, or the data set determined to be relevant to the user prompt 170, such as a data set indicated by the metadata for the previous chatbot response 164). The first request 172 represents a request for an AI/ML model 132 to generate data processing code or instructions for retrieving or generating the data needed to answer the prompt 170. For example, rather than asking the AI/ML model 132 to directly supply the answer to the prompt 170, the first request 172 can request a SQL statement, programming code, a list of operations, or other instructions that specify how to retrieve or calculate the data for answering to the prompt 170. As a simple example, the prompt to the LLM in the first request 172 may include an instruction such as “provide a SQL statement that retrieves the data needed to answer the question «user prompt»,” or “generate Python code that can run on«database system» to calculate the answer to the question «user prompt»,” where the fields indicated are replaced with the user prompt and type of database system used. The content of the first request 172 can be designed for the particular AI/ML model 132 and its capabilities.

As a result, the first request 172 can be a request for a SQL statement or Python code that, when interpreted or executed by another system such as the database system 120, will cause the other system to retrieve and/or generate a focused subset of data (e.g., a result data set) from the data set 122a that can be used to answer to the prompt 170 from the dataset 122a. The first request 172 can also include one or more custom instructions that the administrator specified, to further orient the AI/ML model 132 to generate data processing instructions that are most applicable for the tasks, situations, purposes, or users that the chatbot is designed for. In some cases, one or more custom instructions are appended or otherwise included with the user prompt 170 in the first request 172.

To enable the AI/ML model 132 to accurately answer the prompt 170, the computer system 110 can include in the request 172 information that specifies the interpretations, SQL statement(s), data mappings, and data processing parameters used to generate the previous chatbot response 164. As noted above, this can include information from the conversation history (e.g., some or all of the prompt 163 and chatbot response 164), but can also include additional metadata that is not in the conversation history. For example, the SQL statement used to retrieve the data shown in the chatbot response 164 or interpretations or data mappings derived from that SQL statement are not part of the chat conversation, but the computer system 110 can include them to maintain a consistent interpretation over the series of prompts and responses. In other words, the metadata that the computer system 110 generates for the chatbot response 164 (e.g., interpretations, data mappings, and data processing parameters indicated by the metadata), can act as a filter for the generation of the response to the prompt 170.

Many AI/ML models 132, such as LLMs, operate in a substantially stateless manner, in which a general model 132 does not automatically include context of previous interactions or specific knowledge about the chatbot being used. In addition, the chatbots provided by the computer system 110 do not need to have a one-to-one relationship with the AI/ML models 132. For example, a single model 132 may serve as the model for many different chatbots that are created and hosted using the computer system 110. Creating and customizing a chatbot does not require training or updating an AI/ML model 132, and instead can define parameters of the chatbot experience that are separate from the AI/ML model 132 (e.g., LLM) itself (e.g., parameters such as the data set used, the custom instructions provided with user prompts, whether Internet data can be used, the format and preferences for answers, and so on).

In order for the AI/ML model 132 to be able to appropriately answer the first request 172 and provide data processing instructions to answer the prompt 170, the computer system 110 can include with the request 172 information about the dataset 122a and the database system 120. For example, the first request 172 can include metadata about the structure and contents of the dataset 122a, without including actual data of the dataset 122a. For example, the metadata may include a database schema, a description of the dataset structure, a description of semantic, meaning of the tables, columns, and other elements of the dataset, and so on. The request 172 may also include sample data, such as a few rows of data or fictitious computer-synthesized data that is of the same type and structure as the dataset 122a, but does not include the actual values from the dataset 122a.

For example, the first request 172 can indicate the types of data in the dataset 122a, and include a sample row or rows of data from the dataset 122a. The request 172 can also include information about the capabilities of the database system 120 and the data processing functions and manipulations that are available. For example, the request 172 can include instructions or description how to interact with the database system 120 to perform various processing functions, such as commands for sorting, filtering, joining, and otherwise manipulating data. In some cases, this information may include text of a user manual or other human-readable text describing the use of the database system 120. As another example, the request 172 can include a table of available commands for manipulating data in the database system 120, an API description for the database system 120, a list of valid interactions and their effects, or other data.

The first request 172 can be generated or adjusted based on information in the long-term memory 148 or other information about the user. For example, given the user interactions or feedback received through prompt-response cycles with the user 105c and/or other users, the long-term memory 148 may include information that can clarify what users intend when they ask a question as indicated in the prompt 170. For example, the long-term memory may specify that a visualization should be included, or that data should be ordered in a particular way. In addition, the computer system 110 also stores information about the user 105c and his current context, represented as user context data 156. This user context data 156 can indicate, for example, the identity of the user, permissions of the user, a device type of the user's device 106c, a location of the user, a role of the user, a department of the user, and so on. In addition, the computer system 110 stores conversation histories 157 of users that have previously interacted with the chatbot. As a result, information about previous prompts from the user 105c and previous responses, in whole or in part (e.g., in summary form) and from the current session and/or previous sessions, can be retrieved and used to supplement the prompt 170. The computer system 110 can provide the user context data 156 and conversation history 157 for the user 105c in or with the request 172, so the AI/ML model 132 can generate data processing instructions with the context of the user's situation and previous conversations, which may better explain or help disambiguate the most recent prompt 170.

In stage (C), the AI/ML service provider 130 uses the AI/ML models 132 to generate a response to the first request 172. The AI/ML service provider 130 then sends the response, a set of data processing instructions 174, to the computer system 110. As discussed above, the first request 172 requests instructions specifying the processing operations that the database system 120 can use to retrieve and/or generate (e.g., calculate) from the dataset 122 the result data that would be needed to answer the user prompt 170. As a result, the AI/ML service provider 130 uses the AI/ML models 132 to generate the data processing instructions 174 that, when executed by the database system 120, will retrieve and/or generate the data needed to answer the prompt 170. In this process, the system 100 leverages the ability of the AI/ML models 132, e.g., LLMs, to generate a set or sequence of instructions or operations. The data processing instructions 174 can be expressed in any of a variety of ways, such as one or more SQL statements, as executable or interpretable code, such as Python code, as a list of API calls or commands to be executed, and so on.

In stage (D), the computer system 110 uses the received data processing instructions 174 to instruct the database system 120 to obtain (e.g., retrieve, calculate, generate, etc.) the data needed to answer the user prompt 170. For example, the computer system 110 may send a request that includes the data processing instructions 174 to the database system 120, in order to request the needed data. In some implementations, the computer system 110 may apply a set of rules or validation checks to verify that the data processing instructions 174 are valid and appropriate to be executed by the database system 120. For example, the computer system 110 can store rules that can be used to evaluate the data processing instructions 174 element by element and/or as a whole to verify and correct the data processing instructions 174 if needed before they are sent to the database system 120.

When interacting with the AI/ML service provider 130 and/or the database system 120, the computer system 110 can apply the customized settings and properties that the administrator defined for the chatbot. For example, the administrator can limit which portions of the dataset 122a can be accessed by the chatbot, and so the computer system 110 can apply those limits so that the first request 172 to the AI/ML service provider 130 does not reference omitted data (e.g., excluding from the description of the data set 122a columns or tables that are not to be referenced, so the AI/ML models 132 cannot use them or even determine that they exist). Similarly the first request 172 can include instructions to specifically exclude or avoid using certain data. In addition, or as an alternative, the computer system 110 can filter, edit, or otherwise check the data processing instructions 174 so that the operations specified do not draw from or become calculated based on excluded data. In addition, or as an alternative, the computer system 110 can analyze the results 176 to verify that the results 176 do not include or are not based on the excluded data.

As another example, the computer system 110 can apply access control policies or custom behavior based on the identity or role of the user 105c issuing the prompt 170. Those custom behaviors can be reflected in the interactions of the computer system 110 to the AI/ML service provider 130, such as in the request 172, as well as in the interactions with the database system 120.

In stage (E), the database system 120 generates and sends results 176 that include the data retrieved from and/or generated based on applying the data processing instructions 174 to the dataset 122a. The database system 120 processes or executes the data processing instructions 174 that it receives, which creates the results 176, which may be in any of various forms, such as a new table of result data, records retrieved, data series, aggregations of data, statistics about data in the dataset 122a, subsets of the dataset 122a determined to be relevant, and so on.

In the illustrated example, the user prompt 170 asks to see trends by product for the “top 5,” which implicitly refers to the data from the chatbot response 164, which refers to which regions have the greatest revenue over the last year. The data processing instructions 174 generated by the AI/ML models 132 specify the operations needed to generate data series showing trends, or values over time, for measures of revenue by region for the previous year. For example, the data processing instructions 174 may include a SQL statement to retrieve these values, or may include a set of instructions in a programming language, such as Python. The results 176 generated by the database system 120 include the values needed to answer the question in the user prompt 170. In other words, the results 176 include values of revenue for the regions specified in the dataset 122a, with multiple data points over time to show trends, appropriately labeled or associated with identifiers for those regions. In this process, the AI/ML models 132 have been leveraged to obtain the results 176, however, the AI/ML models 132 did not need or receive access to the dataset 122a itself, and the AI/ML models 132 did not incur the resource costs of having to process the dataset 122a. In addition, the database system 120 and its reliable, repeatable calculations ensure that the results 176 are accurate, without the AI/ML models 132 introducing uncertainty into the calculations.

In addition, the dataset 122a may be very large, much larger than the maximum context length of an LLM used for the AI/ML model 132. In many cases, the amount of data in the dataset 122a may be orders of magnitude larger than the maximum context size that the LLM can process. The database system 120 can process a large dataset much more quickly and with greater power efficiency than an LLM can. Due to limits on LLM context sizes, it may be impractical or impossible for an LLM to analyze the dataset 122a to generate the needed results 176.

In stage (F), the computer system 110 sends a second request 178 to the AI/ML service provider 130. The second request 178 includes the results 176 and requests that the AI/ML models 132 generate an answer to the prompt 170 based on the results 176 retrieved from the data set 122a. In some cases, the answer may be a summary, a description of the results 176, or another text response that answers the prompt 170 based on the results 176. For example, the second request 178 may be a request to answer the prompt 170 using the data in the results 176 as context or as source data for the answer. As another example, the second request 178 may be a request for the AI/ML models 132 to summarize or describe the results 176, in addition to or instead of answering the user prompt 170. The second request 178 can also include one or more custom instructions that the administrator specified, to further orient the AI/ML model 132 to respond in the format and with the content that is most applicable for the dataset 122a and/or the overall purpose for which the chatbot was designed (e.g., customization for a particular organization, set of users or user roles, set of tasks, etc.). In some cases, one or more custom instructions are appended or otherwise included with the user prompt 170 in the second request 178.

As with the first request 172, the computer system 110 can include in the second request 178 metadata characterizing the previous chatbot response 164 or even other earlier relevant portions of the conversation. For example, this data can indicate the previous interpretations, SQL statement(s), data mappings, data sets, data objects, etc. to enable a consistent interpretation to be carried forward through the conversation as follow-up questions and progressively detailed analysis is requested. The computer system 110 can also provide the user context data 156 and conversation history 157 for the user 105c in or with the second request 178, so the AI/ML model 132 can generate a response based on the context of the user's situation and the user's previous conversations, which may better explain or help disambiguate the most recent prompt 170. The computer system 110 can also provide information from the long-term memory 148 that the computer system 110 determines to be relevant, potentially as determined to be relevant specifically to the user 105c, the user context data 156, and/or the prompt 170.

In some implementations, the chatbot is configured to generate visualizations as part of the response to a user prompt 170. To create these visualizations, the computer system 110 can include in the second request 178, or as an additional request, a request for the AI/ML models 132 to indicate an appropriate type and format of visualization for the response to the request 178. The AI/ML models 132 can then be used to specify the parameters for the visualization, such as the type of visualization (e.g., line chart, bar chart, line graph, geographical map, heat map, etc.), and identification of which data items are shown on different axes or dimensions of the visualization, the ranges to show, the labels to use, the color scheme, and or other properties. In other implementations, the computer system 110 itself generates visualizations for chatbot responses based on the result data 176, potentially without relying on an AI/ML model 132 to generate the visualization.

In stage (G), the AI/ML service provider 130 uses the AI/ML models 132 to generate a response to the user prompt 170, e.g., a response content 180 that may include a summary of the results 176 or other response requested by the second request 178. For example, the second request 178 may include or provide access to the results 176 and the user prompt 170, and so the AI/ML models 132 answer the prompt 170 from the context provided by the results 176. In some implementations, the answer to the user prompt 170 may be a summary of the results 176 and/or may include values extracted from the results 176 with added text description generated by the AI/ML models 132.

For example, in the illustrated example, the AI/ML models 132 indicate the specific regions having the greatest revenue, as requested by the prompt 170, along with an indication of the revenue values taken from the results 176, along with other description and contacts. If the request 178 requests information about a visualization, or if the AI/ML models 132 determine that a visualization is likely appropriate or beneficial, then the response content 180 can include a visualization description. The visualization description can specify the properties recommended for a visualization of the results 176 as a whole, or for specific items that answer the user prompt 170.

In stage (H), the computer system 110 generates metadata that describes the context and interpretations used to generate the response content 180. For example, the computer system 110 can include the data processing instructions 174 (e.g., SQL statement) or the selection of data sets and data objects and their mapping to terms and concepts in the prompt 170. The data processing criteria used to generate the results 176, such as filters applied, data aggregations performed, sorting performed, and so on, can also be included. In addition, the metadata can include topics, keywords, and other indicators of the current context, including those carried through from previous prompts and responses (e.g., prompt 163 and response 164), especially if those are relevant to the interpretation of or disambiguation of references in the prompt 170. For example, the reference to “top 5” in the prompt 170 refers to top 5 regions having the highest revenue, which may be determined or extracted from the response 174 or the prompt 163, or may be determined from the data processing instructions 174 which show the ranking or selecting regions by revenue as part of the data processing performed.

In stage (I), the computer system 110 processes the response content 180, and generates and sends a response 182 as the answer of the chatbot to the user prompt 170. The response 182 is then displayed on the user interface 162 of the client device 106c. The computer system 110 can process the response content 180 to create the response 182, for example, by applying customized settings or policies specified in the saved chatbot configuration data 146. In this way, the computer system 110 can apply customized style, formatting, content preferences or restrictions, and other customizations that were defined by the administrator. In addition, or as an alternative, the computer system 110 can incorporate those customizations when making the request 178. For example, the computer system 110 may include in the request 178 preferences for a concise or verbose answer, the tone or style of text used, and other preferences.

When a visualization is requested by the prompt 170 or suggested by the AI/ML models 132, the computer system 110 may generate a visualization based on the results 176. In this manner, the visualization that is provided is based on reliable, accurate data or calculations in the results 176 and/or the dataset 122a. For example, the visualization that is rendered has the type of data specified by the AI/ML model 132, and in the arrangement specified by the AI/ML models 132, but with values or data series shown being determined through data retrieval and/or calculations of the database system 120 to ensure accuracy and reliability.

The computer system 110 can embed the metadata determined in stage (H) in the response 182 or associated the metadata with the response 182. Then, if a user returns to the response 182 in the future, the context can be preserved. Importantly, the metadata can preserve the data context, e.g., the data set used, the data objects used from the data set, mappings of terms and concepts to the data objects, data processing criteria, etc. This can be provided in addition to or instead of the conversation's text context, e.g., the text of the prompts and responses that precede the response 182 in the chatbot conversation.

The computer system 110 can store visualization data 190 that defines visualizations, for later use or viewing by a user. The visualization data 190 can include the metadata for the chatbot response in which the visualization was generated. As a result, when a user selects a visualization, the computer system 110 can restore the relevant context (e.g., data context and conversation context) from the metadata, so the chatbot can accurately answer about the same data set and with interpretations consistent with those used before.

The computer system 110 can also provide features that enable users to save chatbot responses, e.g., as “snapshots,” for later viewing or other use (e.g., export to other programs, sharing with other users, saving to disk, copying to the clipboard, refreshing with updated data, etc.). For each user, the computer system 110 can store snapshot data 192 storing the saved content of a chatbot response and the associated metadata. As discussed above, the stored metadata enables the chatbot to recreate or restore the relevant context for the saved chatbot response, including interpretations of terms, mapping of terms and concepts to data sets and data objects, and other data processing criteria so the chatbot can accurately and consistently respond to further questions regarding the chatbot response or the underlying results.

Through any and all of the interactions of the computer system 110 to generate and provide the response 182, the computer system 110 applies the settings and properties specified in the saved chatbot configuration data 146. As a result, the behavior and characteristics that the administrator specified for the chatbot can be enforced at any or all stages of the process to provide the customized interface and chatbot behavior that the administrator desired.

After an administrator customizes a chatbot or other interactive application, the computer system saves the interactive application (e.g., as a new or updated chatbot) and makes the application available to other users. For example, the computer system can send hyperlinks or invitation messages to users, so the users can access a chatbot through a web page or web application. As another example, the computer system can include code to integrate the chatbot into an existing web page or web application (e.g., as an embedded item, in an iFrame, etc.). As another example, the computer system can integrate with document libraries, file browsers, document viewers, web browsers, or other types of user interfaces. As a result, the chatbot can be made available through any of various enterprise software platforms and applications. The interface of the chatbot can then be invoked by interacting with an icon or menu item for the chatbot, or by entering a user prompt into a text entry field of a user interface. In some implementations, the interface of the chatbot can be provided together with a document viewer, for example, in a sidebar or tab shown concurrently with the document viewer interface. This arrangement can enable the user to view a document, such as a dashboard related to a dataset, while concurrently having a conversation with a chatbot designed to answer questions about the dataset.

The computer system enables interactive applications to be tailored or targeted for specific data sets. For example, each interactive application that is created or customized can provide responses with information derived from a corresponding data set specified by the administrator, such as a private data set (e.g., a database table, a data cube, a spreadsheet, etc.). The system enables administrators to create and deploy multiple interactive applications that can be used concurrently. For example, different chatbots that have different behavior tailored for different sets of users. Similarly, different chatbots can be configured to provide data from different source data sets. Administrators can create and deploy different instances of chatbots and other interactive applications, each with customized behavior, appearance, and other characteristics as appropriate for their respective data sets and users.

The computer system enables administrators to customize AI/ML-enabled chatbots very quickly, without the need to re-train an AI/ML model. In particular, after specifying the customizations for the chatbot, no model training is needed and so the chatbot can be used right away. The system can provide a preview interface or test interface that enables an administrator to change chatbot settings and try out the updated chatbot in the generation or editing interface, to see the effects of changes in real time or near real time. To facilitate customizability and the rapid generation of chatbots, the customizations to the chatbot can be made outside the training state of the AI/ML chatbot itself, for example through the selection of which existing AI/ML model(s) to be used, which dataset(s) being used, which portions of a dataset are accessible, and the parameters or characteristics of interactions with the AI/ML model(s). Customizations can also be implemented in operations of a non-AI/ML processing system, for functions such as access control, precision or granularity of data access, and so on. With the ability to provide chatbots without the need to train or re-train AI/ML models, the system allows rapid generation and deployment of chatbots with minimal up-front computing resources and no training delay.

The computer system can support interactive applications where processing tasks for responding to a user prompt are split between non-AI/ML or non-probabilistic data processing systems AI/ML models (e.g., database management systems) and AI/ML models. For example, when a user prompt such as a natural language query is received, the computer system can use a database system to generate a set of result data that is relevant to the user prompt. The set of result data can then be processed using one or more AI/ML models, such as a large language model, to generate content to present in a response to the user. This system can combine the strengths of AI/ML models and non-AI/ML processing systems to provide a chatbot or other application with responses that are more complete, accurate, and reliable than either type of processing system on its own.

In general, many AI/ML models have excellent generative capabilities and the ability to produce high-quality natural language output. However, AI/ML models also often have significant limits. For example, AI/ML models typically use probabilistic processing, which may generate responses that are generalized or approximate, and so may not adequately answer a user's question or may lack the accuracy or precision needed. In some cases, AI/ML models provide content that includes hallucinations or other information that may be statistically plausible given training data but is actually factually incorrect. The probabilistic nature of AI/ML models can also result in the same user prompt resulting in significantly different responses at different times, which can decrease users' confidence and ability to rely on the responses. For example, the same question may yield different numerical answers when the question is asked multiple times to an AI/ML model, even when the source data set has not changed.

As discussed further below, the computer system can provide chatbots and other interactive applications that combine the advantages of AI/ML models and the reliability and accuracy of other non-AI/ML or non-probabilistic data processing systems, such as relational database systems. Database management systems and other systems can reliably provide result data that is accurate and reliable, calculated from the source data using proven and validated processes. For example, data processing systems can be used to search a data set and make calculations, perform aggregations, and generate values in a data series in a repeatable or deterministic manner. This can be done even over large data sets, which may be much larger than an AI/ML system can accept as input context. In addition, the processing can be focused on the specific data set of interest, without extraneous data influencing the calculations as might occur in the probabilistic processing of an AI/ML model trained on large quantities of other data.

When the interactive application is used to respond to a user prompt, the non-AI/ML data processing system (e.g., a database management system) generates result data relevant to the user prompt (e.g., user's question) from the source data set. The user prompt and the result data set, potentially with other information and context, can be provided to the AI/ML model to generate text output for the response to the user. For example, the computer system can send a request for the AI/ML model to summarize the result data set or to generate a response to the original user prompt from the result data set that has been generated. As a result, the text that the AI/ML model generates can draw from values calculated accurately from the source data set, without requiring the AI/ML model to be capable of generating those values itself or without the AI/ML model even accessing the data set. As a result, the output to the user combines the reliable, accurate calculations from the non-AI/ML system with the text and other information provided by the AI/ML model from the result data set.

Combining the processing of AI/ML systems and non-AI/ML systems in the chatbots enhances privacy by limiting the amount of data that the AI/ML model or any other third parties receive. This can provide users with higher confidence in using the system, as well as allow the use of a wider range of third-party AI/ML service providers. When processing queries relating to a data set, the AI/ML model does not need to receive the full contents of the underlying dataset that the chatbot is based on. Indeed, in many cases, the AI/ML model does not receive even portions of the actual dataset, and instead receives only metadata describing the general contents and/or structure of the data set (e.g., types of metrics and attributes, semantic meaning of the columns, etc.) and potentially sample data (e.g., fictitious examples that illustrate the type of content in the dataset without revealing the actual values and records). In addition to enhancing privacy, this also increases speed and reduces network transfer requirements, since the dataset does not need to be sent over a network and the dataset itself does not need to be processed by the AI/ML model. The process also allows the data processing system (e.g., an enterprise database management system) to reliably apply security policies and access control over the dataset that the AI/ML model typically would not be capable of applying. After the data processing system performs processing to generate a result data set, the AI/ML model is provided the result data set and asked to generate a summary. In this interaction, the AI/ML model receives the result data set that generally includes aggregated or composite information specifically answering the user's question, and the AI/ML model does not receive access to the underlying dataset itself. As a result, the system avoids granting the AI/ML model- and any third-party providing the AI/ML model as a service-access to portions of the dataset that are not appropriate for answering the current question.

The customizations that the administrator set in creating or customizing the chatbot can be used to alter the operation and results of the non-AI/ML data processing system, the AI/ML model, the front-end interface that the user sees, or a combination of any or all of them. For example, the customizations that the administrator selects can specify which dataset(s) to use when answering questions, whether additional public datasets or the Internet can be used to answer questions, which portions (e.g., columns, rows, data types, etc.) of datasets can be accessed, and so on. In addition, the customizations that the administrator selects can specify output characteristics for the chatbot such as the style, formatting, media type (e.g., text, images, text and images, etc.), and other properties of answers.

In some implementations, the chatbots can be configured to generate visualizations in response to questions and other user prompts. These visualizations can also be generated through a combination of processing by AI/ML models and non-AI/ML processing systems. For example, if a user prompt requests a visualization or if a visualization is otherwise appropriate for a response, the AI/ML model can specify the type of visualization (e.g., bar chart, line graph, pie chart, etc.) and other properties (e.g., data series shown, scale and data on the axes, etc.). The actual values to be displayed in the visualization, however, can be calculated by the non-AI/ML processing system, using reliable and accurate calculations from the data set. As a result, the AI/ML system can design and format a visualization appropriate to answer the user prompt, while the actual data populating the visualization is not subject to the uncertainties of AI/ML processing.

In general, splitting response generation among multiple processing systems, e.g., an AI/ML model and a database management system, increases the quality of output and control over the process of generating responses. The arrangement also facilitates customizability by allowing administrators to select different AI/ML models and different AI/ML service providers to customize their chatbots. With the system performing discrete operations leveraging AI/ML models, separate from the core querying of an enterprise's proprietary datasets, the chatbots can be more easily integrated with the processing capabilities of third-party systems.

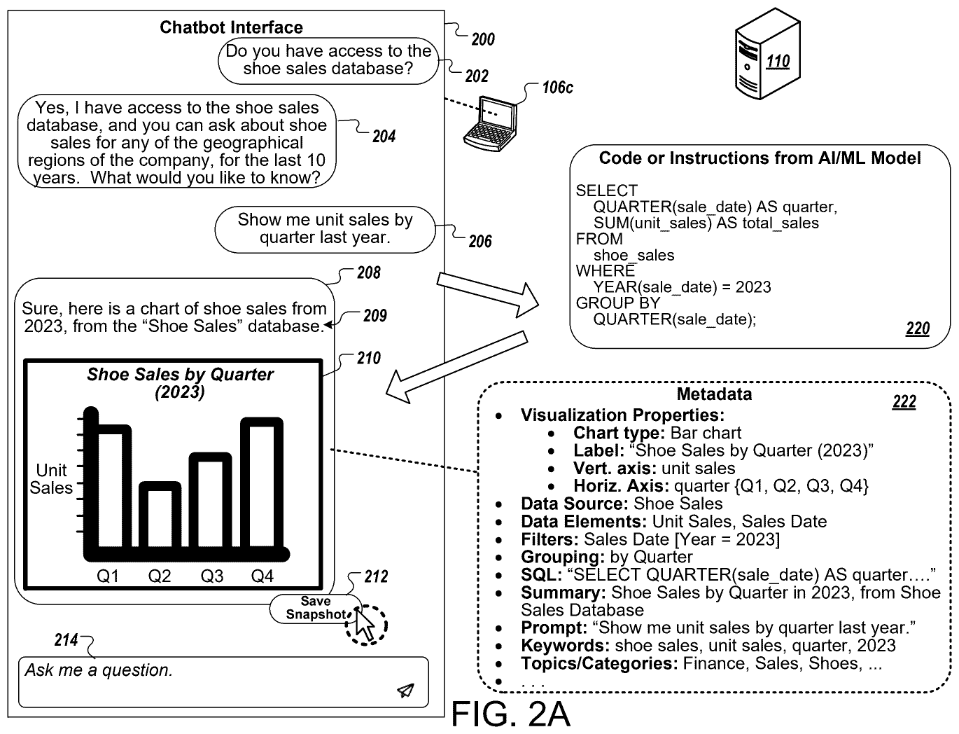

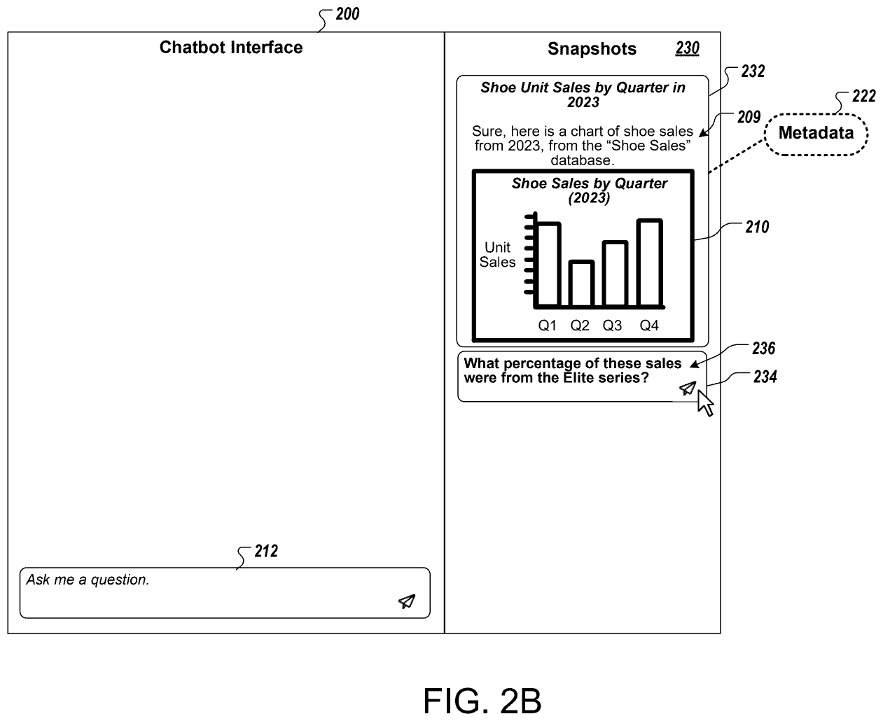

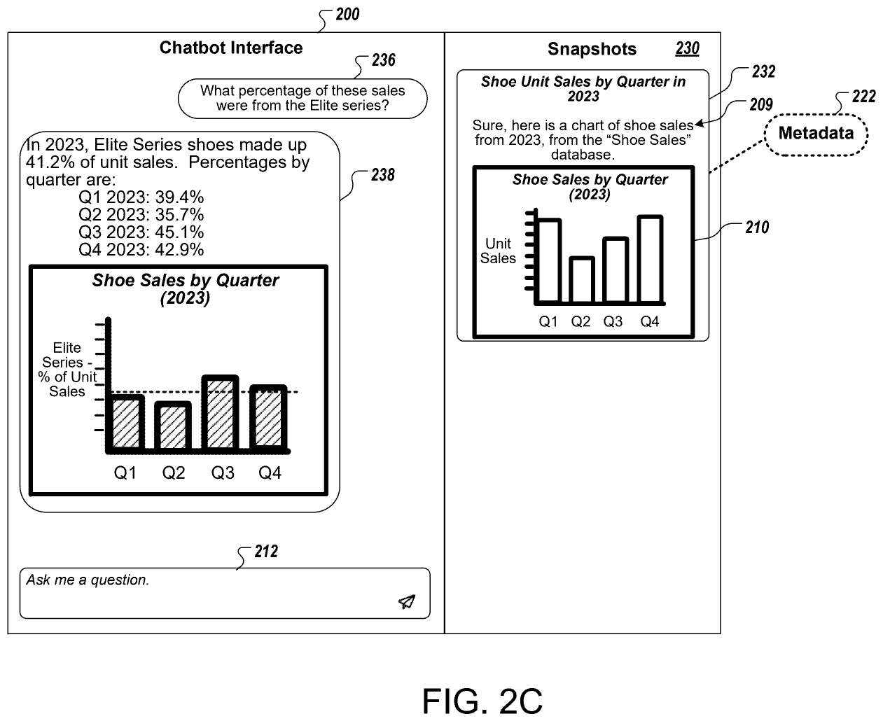

FIGS. 2A-2C are diagrams that show examples of user interfaces for interacting with chatbots, including features to save responses and context information for later use. FIG. 2A shows a chatbot conversation and saving of a chatbot response as a snapshot. FIG. 2B shows a user later accessing the saved snapshot and submitting a follow-up question about the data discussed in the snapshot. FIG. 2C shows the response to the follow-up question, which was generated making use of metadata indicating the interpretations, data mapping, and result data used to provide the chatbot response in the snapshot.

FIG. 2A shows a chatbot interface 200 presented by a client device 106c. The chatbot interface 200 includes a text entry field 214 where a user can enter a question or other user prompt to submit to the chatbot. In the example, the user has entered a first prompt 202, “do you have access to the shoe sales database?” The computer system 110 receives the prompt 202 and uses the techniques described with respect to FIG. 1 to generate and provide the answer as chatbot response 204.

The user then submits another prompt 206, “show me unit sales by quarter last year.” The computer system 110 again receives the prompt 206 and uses the techniques of FIG. 1 to generate the chatbot response 208. When answering the prompt 206, the computer system 110 uses the earlier context of the conversation to interpret and respond to the prompt 206. For example, the user asked about the shoe sales database in the prompt 202, and this same database or data set is also referred to in the chatbot response 204. With this context, the chatbot response 208 is generated based on the same shoe sales database referenced earlier in the conversation. Generating the response involves first using an AI/ML model 132 to generate code or instructions 220 (e.g., an SQL statement). As illustrated, this involves selecting unit sales data in a “unit_sales” column of the “shoe_sales” data table, and using the “sales_date” column to group sales by quarter in the year of interest, e.g., 2023. The computer system 110 then processes the SQL statement to obtain the result data that the database system 120 generates from processing the SQL statement. The computer system 110 then provides the result data to the AI/ML model to generate the text response 209 to the prompts 206, and the computer system 110 also uses the result data to generate a visualization 210 showing the result data.

As part of generating the chatbot response 208, the computer system 110 also generates or compiles a set of metadata 222 that captures significant aspects of the context used to generate the chatbot response 208. The computer system 110 can embed the metadata 222 in the chatbot response 208 or in the visualization data for the visualization 210, or the computer system can associate the metadata 222 with the chatbot response 208 or visualization 210 in another way (e.g., in storage of the computer system 110). The metadata 222 can include a variety of contents, including visualization specifications or visualization properties that define the characteristics presented in the visualization 210. For example, these properties can include parameters that enable the visualization to be rendered, including features such as a type of visualization, a label presented in the visualization, a data type or unit of measure for each axis, labels for each axis, data series to be presented, labels for the data series, a template for the visualization, a color scheme for the visualization, layout and formatting information, and so on.

The metadata 222 can also indicate information about the data source and data objects used to generate the chatbot response 208. For example, the data source is specified to be the “Shoe Sales” data table or data set, and the data elements used are specified as “Unit Sales” and “Sales Date.” In this manner, the metadata 222 can specify the source of data used to generate the chatbot response 208, as well as the data objects (e.g., metrics and attributes) or data set elements (e.g., columns, rows, etc.) used. In addition, the metadata 222 can indicate the subset of data from the data set and how the data is processed to obtain the result set. For example, this can include specifying filters applied, such as a sales date occurring in the year 2023, and an aggregation or grouping of data used, such as showing grouping by quarter.

In some implementations, the metadata 222 includes the code or instructions 220 that were used to retrieve or generate the result data. In this example, the metadata two to two includes the SQL statement that retrieves the data shown in the visualization 210. In addition, or as an alternative, the metadata 222 can specify specific interpretations of terms and slash or mapping of terms to data sets and data objects. For example, the computer system 110 can extract interpretations from the SQL statement in the code or instructions 220. This can specify that, for example, the phrase “unit sales” in the prompt 206 is interpreted as column “unit_sales” of data table “shoe_sales.” More generally, the interpretation may specify that unit sales is interpreted as unit sales for shoes, given the overall context of the conversation and specifically the usage in the prompt 202 and the response 204. In many cases, these interpretations or mappings of data sources and data objects to terms or concepts in the natural language text of a prompt or chatbot response may not be apparent from or may not be derivable from the natural language text. As a result, including the code or instructions 220, or interpretations derived from the code or instructions 220, provides an additional type of context or insight that is not available from simply copying or saving the chatbot conversation. Although many chatbot systems provide the text of a conversation as context for answering a subsequent user prompt, these other systems many times do not use or even have access to any intermediate output from a multi-stage interaction with AI/ML models 132. In the present system, this intermediate information provides increased accuracy and reliability, and especially consistency across answers, with or without the prior conversation being provided to an AI/ML model.

The metadata 222 can include other information that is extracted from or generated based on the chat conversation. For example, the computer system 110 can request that an AI/ML model 132 generate a summary of the result set, the chatbot response 208, or even the chat conversation as a whole. For example, in this case, the AI/ML model 132 generated a summary that the data discussed in the response 208 is “shoe sales by quarter in 2023 from shoe sales database.” The metadata 222 also includes the prompt 206 immediately preceding the chatbot response 208.

Nevertheless, the prompt 206 does not mention shoe sales, and so it does not alone provide sufficient context to interpret the meaning of “unit sales.” As a result, the computer system 110 can include other information, such as the SQL statement data source, data elements, and so on that are derived in part based on information from earlier interactions in the conversation. In addition, or as an alternative, the computer system 110 can identify keywords or topics from the conversation that relate to the chatbot response 208. In many cases, the conversation may be much longer than the two interactions shown in the example. As a result, many previous prompts and chatbot responses may not be relevant or may only have portions that are relevant to the chatbot response 208. The computer system 110 can selectively extract a subset of the prompts or responses relating to the same topic as the chatbot response 208 (e.g., involving the same data set or data objects as the response 208) or extract portions of prompts or responses.

In the example of FIG. 2A, the chatbot interface provides a user a snapshot control 212 that the user can select to save the response 208 as a snapshot for later use. The user clicks the snapshot control 212, and in response, the computer system 110 saves the chatbot response 208 and its associated metadata 222. The computer system 110 can store a separate set of snapshots (e.g., saved chatbot responses) for each user, so that each user can then be shown the chatbot responses that he or she generated and saved.

In FIG. 2B, the user returns to the chatbot interface 200 after time has passed. For example, hours, days, or weeks later, the user may begin a new chat session with a chatbot using the chatbot interface 200. In this example, the prior conversation from FIG. 2A has ended and may have even been deleted or discarded. Nevertheless, the chatbot interface 200 includes a snapshot region 230 that shows saved chatbot responses, including a snapshot 232 providing the same chatbot response 208 that the user saved in FIG. 2A. The snapshot 232 includes the text 209 of the chatbot response 208 as well as the visualization 210, and the snapshot has the metadata 222 representing the interpretations and context for the response 208. The snapshot 232 also has a title generated by the computer system 110, e.g., based on output of an AI/ML model 132, that more describes the subject of the snapshot 232. Here, the title or summary statement includes more than simply the prior prompt 206, which did not mention shoes. In some implementations, the prompt 206 can also be included in the snapshot 232.

In the snapshot area 230, the interface includes a text entry field 234 where a user can enter a question about the snapshot 232 or the underlying result data. In some implementations, the text entry field 234 can be dynamically presented in response to a user interacting with or hovering over the snapshot 232. The user enters a follow-up question 236, “what percentage of these sales were from the Elite series?,” and then the user submits the question 236. In response, the computer system 110 processes the question 236 as a new prompt, using the context provided by the metadata 222 to interpret the question 236. For example, some or all of the metadata 222 can be provided to an AI/ML model 232 for processing the question 236, e.g., in a first stage to generate code or instructions for data processing and/or when answering the question 236 using retrieved data. Because the metadata 222 describes the interpretations used for generating the content of the snapshot 232 (e.g., the data set, data objects, data filters, data aggregations, and other parameters used), the response to the question 236 can be generated using interpretations and data mappings that are accurate and consistent with the one used earlier, even though the prior conversation and/or session may not be available. In this example, the user is asking to drill down further about the data set represented in the visualization 210. The metadata 222 enables the computer system 110 to use the previous visualization 210 and data processing parameters as a filter to quickly obtain result data used in, or used to generate, the content of the snapshot 232, so that data can be further analyzed as requested by the question 236.

In FIG. 2C, the user's question 236 and a chatbot response 238 are shown in the main region of the chatbot interface 200 showing the active conversation. The computer system 110 has used the metadata 222 to further filter the shoe sale data, as used in the visualization 210, to the portion attributable to the “Elite Series” product line. For example, the computer system 110 can provide the SQL statement from the metadata 222 (e.g., the saved code or instructions 222) and a description that this SQL statement was used to generate the earlier result set. The AI/ML model 132 can then generate an update SQL statement with the additional filter criteria to show the “Elite Series” product sales only. This can ensure that the data set used (e.g., the “sales_data” table) and other interpretations are consistent with those used to generate the content in the snapshot 232, and thus are accurate and as the user expects when generating the chatbot response 238.

In the example, the snapshot 232 is saved and accessed through the chatbot interface 200. The metadata 222 can be saved and associated with a chatbot response or visualization even if shared, exported, copied, or saved in another form. For example, even if the chatbot response 208 or visualization 210 is shared or exported through a messaging platform, e-mail, social media platform, or other channel, the metadata 222 can still be saved and embedded or associated. For example, the chatbot response 208 or visualization 210 can be exported or shared as an object, with the metadata 222 included. As another example, the chatbot response 208 or visualization 210 can be converted to an image file to be exported and shared, and the metadata 222 can be included as metadata of the image file. As another example, the chatbot response 208 or visualization 210 can be assigned a unique identifier, and the metadata 222 can be stored by the computer system 110 in association with the identifier. Then, if a user later adds the chatbot response 208 or visualization 210 to a conversation (e.g., by drag-and-drop to the chatbot interface or another method), the computer system 110 can extract the identifier, look up the appropriate metadata 222 stored in association with the identifier, and then use the retrieved metadata 222 in setting the context for a chatbot response.

The inclusion of the metadata 222 for a chatbot response or visualization provides a variety of benefits. For example, when a user receives a chatbot response 208 or visualization 210 shared by another user, the associated metadata 222 allows the receiving user to continue asking questions about that particular result data and topic, even without the chatbot conversation (e.g., several prior interactions) that may have led to the generation of the chatbot response 208 or visualization 210. In addition, the original user or a recipient can refresh the content of the chatbot response 208 or visualization 210 with new, updated data from the underlying data set. For example, because the SQL statement, interpretations, data mappings, or other parameters are preserved, the computer system 110 can retrieve the relevant result data again based on the current contents of a database, using the same interpretations and data processing actions used earlier.

In general, the metadata for a chatbot response or visualization can provide parameters for data processing (e.g., data retrieval and data filtering). For example, the “WHERE” clause of a SQL statement may refer to directly to a result data table representing data visualized in a source visualization, in order to use the result data (and thus filter properties applied for the source visualization) as filter criteria for the generating a new chatbot response or new visualization. In the saved code or instructions, references in a SQL statement can specify or limit which attributes to retrieve, which metrics to calculate, and/or which filters to apply. By referencing visualizations and tables in this way, the code or instructions in the metadata can maintain continuity by importing logical object definitions and other criteria (e.g., for filtering, sorting, etc.) from one chatbot response or visualization to the next.

The metadata can specify the logical objects to be retrieved and/or calculated from a data set, including any new logical objects to be created (e.g., any new attributes or metrics that are derived from a data set and the equations or expressions used to derive them). At each step in the processing, when generating a request to the AI/ML model 132, in the code or instructions for data processing, in a visualization specification, and when retrieving the results, the metadata for a chatbot response or visualization or a table representation of that data can serve as criteria for data retrieval, data processing, and data presentation, e.g., as a data filter, as a source of object definitions, and so on.

For example, a table of result data or logical objects corresponding to the table can be used to import or define criteria for manipulating data (e.g., retrieving, calculating, filtering, sorting, etc.). As an example, a source visualization may refer to the top 100 customers, and then a SQL statement generated by the AI/ML model 132 based on the visualization may specify to select data from a set of categories by revenue, where customers are taken from the table representing the source visualization. In effect, the properties of the data of the source visualization is used as a filter for the new visualization, specifying that the data is determined for the top 100 customers represented in the source visualization. The visualization specification for the new visualization can reference the source visualization or its table representation to specify this filter, as well as to define the logical objects and/or data set(s) from which the data is obtained.

When the metadata clearly defines logical objects to be used, this helps make visualizations able to be re-created or refreshed. Logical objects of a data set can be referenced directly (e.g., based on the data model or data schema) or indirectly through a table associated with the source visualization (e.g., based on metadata for the table). References to these logical objects, and definitions for newly-defined logical objects if needed, allow the database system 120 to retrieve and calculate all the information needed for a visualization. The metadata can clearly and fully specify the logical objects to retrieve or calculate, so that the visualization specification does not include or depend on a static data set, but instead allows the data for the visualization to be retrieved fresh from the source data set(s). As a result, after a visualization has been created, if the user wants to update the visualization with the most current data, the user can simply select to refresh the visualization and a new set of updated data can be generated and shown in the visualization.

When generating the metadata 222 for a chatbot response or visualization, the computer system 110 can determine the interpretations of the chatbot for each user prompt based on code or instructions that an AI/ML model generates to retrieve data from a data source and/or calculate a result used in responding to the prompt. The system 110 can facilitate this by using multiple interactions with the AI/ML model to answer each user prompt. For example, after a user prompt is received, a first interaction with the AI/ML model can be used to obtain data retrieval code or instructions, such as a SQL statement, that the AI/ML model generates. The data retrieval code or instructions can indicate, in a programming language or other standardized format, the operations or criteria for another system, such as a database system, to apply to retrieve the data that would be used in answering the prompt. The system can analyze the code or instructions generated by the AI/ML model to identify which portions (e.g., columns, rows, tables, etc.) of a source data set are referenced and how those portions relate to the terms in the user prompt. The AI/ML model can also be used to generate natural language text that concisely describes the data and operations represented in the code or instructions. The system can also use the generated code or instructions to retrieve or calculate the values that are needed to answer the user prompt. The system can then provide those values to the AI/ML model and request the answer to the original user prompt, which in many cases include a summary of or analysis of the results that the database system provided based on the code or instructions that the AI/ML model provided earlier.

For example, the computer system 110 can analyze the code or instructions generated by an AI/ML model 132 to identify the logical objects referenced. The computer system 110 can use a semantic graph, pattern analysis, or other functionality to identify how these logical objects correspond to terms or phrases in a user's prompt. For example, the computer system 110 can determine that a region identifier attribute in a SQL statement corresponds to the term “regions” in a prompt and that a profit metric corresponds to the term “profit” in the prompt. The computer system 110 can generate additional interpretation content, such as a list of logical objects from the data set that were involved in answering the user prompt. The computer system 110 can provide the identified logical objects in the metadata for a chatbot response or visualization, along with additional information about them, such as the equations or expressions used to calculate metrics (e.g., profit calculated as the value of a revenue object minus a costs object).

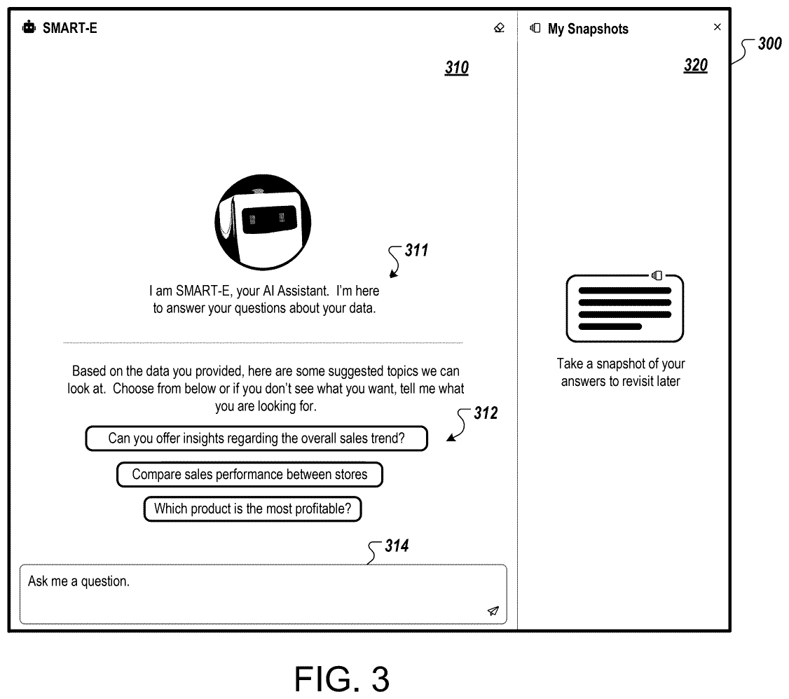

FIG. 3 shows an example of the chatbot interface as it can be displayed on user interfaces of client devices 106a-106c of the users. 105a-105c with which the chatbot has been shared. The user interface 300 includes a chatbot interface 310, in which the user enters prompts to the chatbot and the chatbot provides responses. In addition, the interface 300 includes a snapshot area 320 that shows chatbot answers that the user has saved and for the detail, the chatbot interface 310 includes the greeting 311 that the administrator specified for the chatbot along with the name (“SMART-E”) and logo that the administrator specified for the chatbot. In addition, the chatbot interface 310 includes three suggested user prompts 312 as the administrator specified.

The interface 300 of FIG. 3 demonstrates how a few of the settings that can be specified for the chatbot are carried through to the appearance and operation of the chatbot experienced by users. In addition, the customizations specified by the administrator and saved in the saved chatbot configuration data 146 are also used to customize the content and format of responses generated and provided through the chatbot interface 310. For example, the chatbot provides answers based on the particular dataset that the administrator selected or generated. In addition, the responses generated by the chatbot may optionally be limited to the subset of data from that dataset as specified by the settings selections by the administrator. In addition, interactions of the computer system 110 with the AI/ML models 132 can include or otherwise incorporate the information from the custom instructions specified by the administrator. For example, when the user 105c submits a question through a text field 314 of the chatbot interface 310, the computer system 110 can supplement or augment the user's question with the custom instructions, e.g., as additional prompt content or as context for the user prompt. In a similar manner, the computer system 110 can use the settings for the chatbot, as saved in the saved chatbot configuration data 146, to customize or create each interaction with the AI/ML service provider 130 and AI/ML models 132, with the database system 120, and with client devices 106a-106c. As a result, the saved chatbot configuration data 146 that captures the settings of the administrator for the chatbot can be applied consistently and repeatedly for many users to provide a chatbot experience. In addition, other chatbots that use the same AI/ML models 132 and potentially even the same dataset(s) have their own separate appearance, behavior, and content of responses, as specified by the respective saved configuration data for those chatbots.

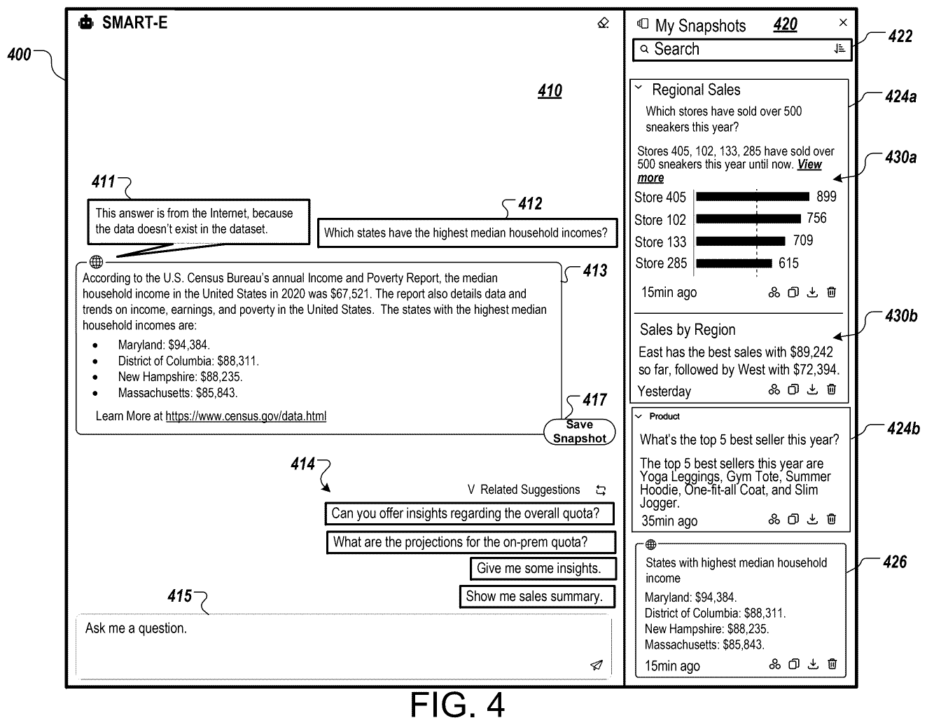

FIG. 4 is another example of a user interface 400 showing user interactions with the chatbot. The user interface 400 has a main area 410 that shows a user prompt 412 that was submitted and the response 413 from the chatbot. The chatbot added a comment 411 that the answer is taken from the Internet data because the data requested about median incomes by state was not in the dataset 122a. In this example, the administrator previously specified that the chatbot can use data from the Internet. As a result, the chatbot was able to determine from the initial request for data processing instructions and lookup from the dataset 122a that the requested type of information was not available, and so the search should be expanded to include information from the Internet. The main area 410 also includes a set of related suggestions 414 that the chatbot provides. These suggestions can be selected based on prior prompts submitted by the current user, other users, and/or statistical likelihoods, even potentially from information generated from a LLM such as one of the AI/ML models 132.

The user interface 410 also includes a snapshot area 420 for viewing, searching, and organizing saved information from conversations with the chatbot. When a user finds information in the chat conversation to be helpful, the user can save the response for later viewing or other use by interacting with a save control 417. In response, the computer system 110 creates and saves a record representing the corresponding prompt 412 and response 413, in this case, as snapshot 426. The snapshots can be concise or summarized versions of the corresponding prompt and response, and these snapshots can be stored separately for each user. The stored snapshots can persist across different sessions of using the chatbot, and can be synchronized across different interfaces for accessing the chatbot. As a result, over the course of several different days, when the user accesses the chatbot at different times, and whether accessed from an embedded interface in a web application or from a stand-alone interface in a mobile app, the user can view the snapshots and add to them.

The snapshot area 420 can include snapshots organized by topic or keyword, for example, a snapshot group 424a includes a first question and answer 430a as well as a second response to a question 430b that is related. Another snapshot 424b relates to another topic. Each snapshot 430a, 430b, 424b, 426 can include controls for the user to expand or contract the view, copy the snapshot content to a clipboard, share with other users, download the content, or delete the snapshot to remove it from the view 420. The snapshot area 420 also includes a search control that enables the user to perform text searching of the snapshots.

Each snapshot 430a, 430b, 424b, 426 can have a corresponding set of metadata associated with it to specify, for example, the interpretations, data mappings, SQL statements, and other context used to generate the respective content. As a result, a user is able to select any of the snapshots 430a, 430b, 424b, 426 to set the context to the corresponding result data and topic(s), and directly submit a question that the chatbot will interpret with interpretations, data sources, data filters, and data aggregations consistent with the selected snapshot.

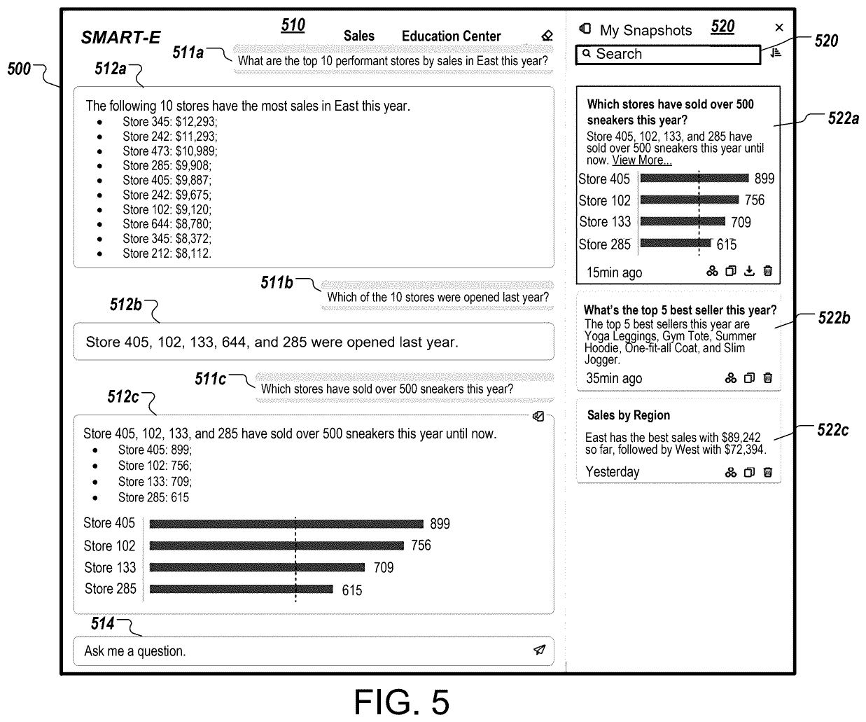

FIG. 5 is another example of a user interface 500 for a user to interact with the chatbot. A main area 510 includes various user prompts 511a-511c and corresponding responses 512a-512c of the chatbot, along with a prompt entry field 514. In addition, the user interface 500 includes a snapshot area 520 with a search control 520 and several saved snapshots 522a-522c that the user previously saved.

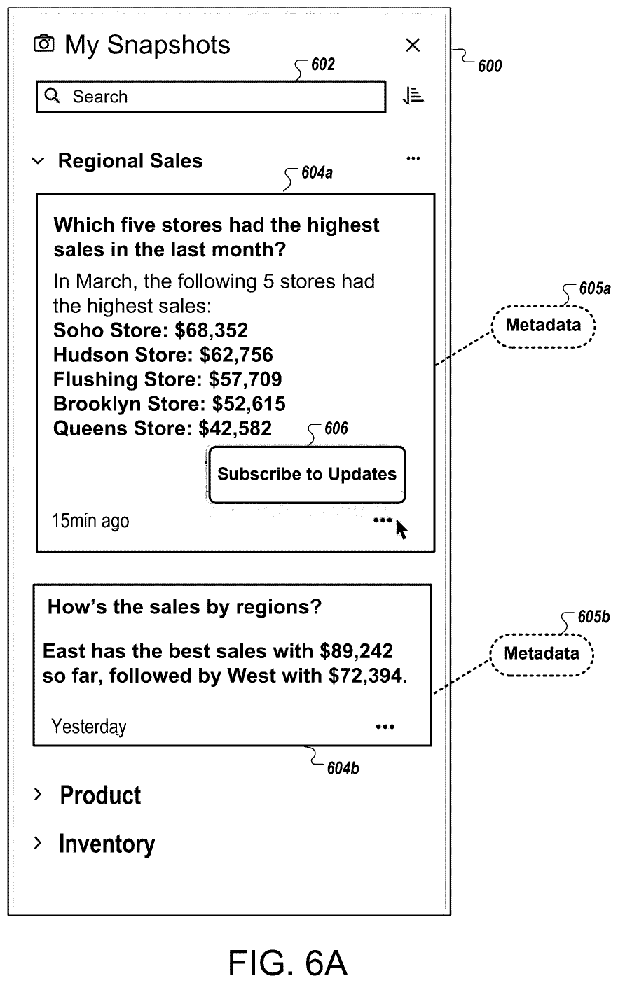

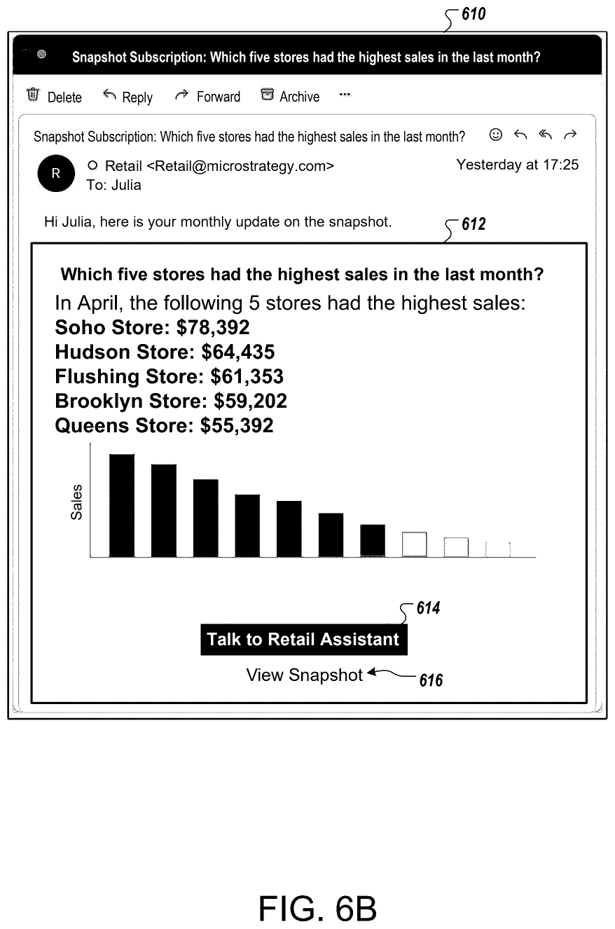

FIGS. 6A-6B are diagrams showing examples of user interfaces showing snapshots from chatbot responses to user prompts and subscriptions to provide updated or refreshed responses to the user prompts over time.

FIG. 6A shows a chatbot interface that includes a snapshot region 600. The snapshot region 600 includes several snapshots 604a, 604b, each representing a different chatbot response that the user has chosen to save. In the snapshot region 600, the snapshots are organized by topic and in particular, based on the data objects or data elements that are the subject of the snapshots. For example, the computer system 110 has identified the snapshot 604a, 604b as both relating to regional sales, because both include sales amounts that are aggregated or specified by location. In addition, other categories of snapshots that the user has saved relate to products or inventory, which represent other categories. The snapshot region 600 includes a search field 602 that allows the user to enter a search query or keyword, and in response, the system will identify snapshots relevant to keyword. For example, the categories and/or snapshots can be filtered to those that match or have at least a minimum level of similarity to the term(s) entered in the search field 602.

Each of the snapshots 604a, 604b has associated metadata 605a, 605b that is determined as discussed above. For example, the metadata 605a, 605b for a snapshot can include the SQL statement used to generate result data describes or depicted, interpretations used, mappings of terms or concepts to data sets and data objects, and so on. The metadata 605a, 605b enables the computer system 110 to quickly and reliably refresh the content of the snapshot (e.g., to re-run the data analysis to update the values for sales amounts in the snapshots 604a, 604b), to maintain or transfer context when answering follow-up questions, and perform other functions.

The snapshot region 600 includes a control 606 that enable a user to subscribe to updates to a snapshot. For example, when the user clicks or hovers over an icon, the subscribe control 606 can be presented in the user interface. When the user clicks the subscribe control 606, the computer system 110 generates a record that triggers updated information about the topic or result data of the associated snapshot to be provided. For example, when the user click the subscribe control 606, the computer system 110 extracts information from the metadata 605a for the associated snapshot 604a to generate a query or data processing action that the computer system 110 will run automatically on behalf of the user and send the user updated results. Because the metadata 605a includes the SQL statement or other specification of data processing parameters to obtain the result data, the computer system 110 can reliably create a query that will rerun the prompt or question that led to the chatbot response in the snapshot 604a. For example, the computer system 110 can repeat the generation of the answer to the question “Which five stores had the highest sales in the last month?,” using the same data set and data objects (as well as other data processing criteria such as filters, aggregations, sorting, etc.) used to generate the content in the snapshot 604a.

In some implementations, the computer system 110 fulfills the subscription by periodically performing the generated query based on the snapshot 604a and metadata 605a, such as by generating and sending a new updated copy at a regular interval, such as each day, each week, each month, and so on. As another example, the computer system 110 can monitor the data set and detect when changes in the data set would change the values in the snapshot 604a. Then, when the computer system 110 detects that the content would change, or would change by at least a minimum amount, the computer system 110 can generate and send updated content with the new values. In this way, the computer system 110 can provide updates to the user responsive too changes in the values answering the question in the snapshot 604a that is the subject of the subscription.

FIG. 6B shows an example of an e-mail interface 610 showing a message that the computer system 110 caused to be sent as part of fulfilling the subscription made by the user. In this example, the subscription result in a monthly update to the snapshot 604a from FIG. 6A. As a result, each time a month has elapsed, the computer system 110 re-runs the query defined for the subscription, e.g., the prompt “Which five stores had the highest sales in the last month?” and sends the answer as an updated snapshot 612 to the user. Because metadata 605a preserves the SQL statement or other information indicating interpretations and context for the snapshot 604a, the answer can be consistent with and provide a direct comparison to the previous content of the snapshot 604a. Note that where the original snapshot 604 provided data for the month of March, the updated snapshot 612 is provided for the month of April. The relevant prompt refers to sales “in the last month,” and so when the snapshot is refreshed after a month, the measurement period is different. This shows how the snapshot subscriptions can be used to obtain a series of updates with a consistent interpretation for different time periods. In some implementations, the computer system 110 determines the update frequency based on the time measures in the user prompt. For example, if the user prompt refers to information by day or about the previous day, then the computer system 110 can set a daily update frequency.

In this example, the message is sent by e-mail, but the messages may additionally or alternatively be sent through a messaging platform, an application, or other channel. The subscription and its updates make the snapshot 604a dynamic, effectively re-running the SQL and/or the question. The computer system 110 use the same SQL generated before, or at least provide it to the AI/ML model 132 when generating updated SQL, to maintain the same interpretation, data source, etc. This provides updated data from the dataset, while also maintaining a consistent interpretation as the user expects.

The updated snapshot 612 includes a control 614 that a user can interact with to initiate a chat conversation with the chatbot (e.g., the “Retail Assistant” chatbot). The control 614 can be provided with a link or reference so that, when the user selects the control 614, a chatbot interface is invoked and the context of the updated snapshot 612 is transferred to or maintained in the chatbot interface. This will help target the chatbot's response to the data set, logical objects, data elements, topics, and keywords related to the content of the updated snapshot 612. The updated snapshot 612 also includes a control 616 that a user can select to call up the snapshot region 600 to view the original snapshot 604a on which the subscription is based, as well as to view other snapshots that the user has saved.

A number of implementations have been described. Nevertheless, it will be understood that various modifications may be made without departing from the spirit and scope of the disclosure. For example, various forms of the flows shown above may be used, with steps re-ordered, added, or removed.

Embodiments of the invention and all of the functional operations described in this specification can be implemented in digital electronic circuitry, or in computer software, firmware, or hardware, including the structures disclosed in this specification and their structural equivalents, or in combinations of one or more of them. Embodiments of the invention can be implemented as one or more computer program products, e.g., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

1. A method performed by one or more computers, the method comprising:
receiving, by the one or more computers, a user prompt from a user through a chatbot interface that is configured to receive input of user prompts and provide output of chatbot responses to the user prompts of a current conversation in a first region of the chatbot interface;
providing, by the one or more computers, a chatbot response to the user prompt through the chatbot interface, wherein the chatbot response is generated using one or more artificial intelligence and/or machine learning (AI/ML) models based on the user prompt;
providing, by the one or more computers, a control that is associated with the chatbot response on the chatbot interface and is selectable by the user to cause the chatbot response to be saved;
in response to user selection with the control, saving, by the one or more computers, the chatbot response and corresponding metadata that includes context information used by the one or more AI/ML models to generate the chatbot response; and
providing, by the one or more computers, data for a second region of the chatbot interface to display the saved chatbot response that the user selected to be saved, wherein the chatbot interface is configured to receive a subsequent user prompt associated with the saved chatbot response and to provide a subsequent chatbot response that answers the subsequent user prompt using the context information in the metadata corresponding to the saved chatbot response.

2. The method of claim 1, comprising:
displaying, in the second region, multiple saved chatbot responses that the user selected to be saved from different conversations or sessions of interaction with one or more chatbots, wherein each of the saved chatbot responses has corresponding saved metadata that includes context information used by the one or more AI/ML models to generate the chatbot response to which the saved metadata corresponds;
receiving input of an additional user prompt associated with a particular saved chatbot response of the multiple chatbot responses;
generating a chatbot response to the additional user prompt, including providing context information from the saved metadata corresponding to the particular saved chatbot response to the one or more AI/ML models; and
providing the chatbot response to the additional user prompt in the chatbot interface.

3. The method of claim 1, wherein the chatbot interface is configured to display saved chatbot responses for the user in the second region concurrently with display of user prompts and chatbot responses of the current conversation in the first region.

4. The method of claim 1, wherein the second region displays saved chatbot responses that the user selected to be saved from different chatbot conversations or different sessions of interaction with the chatbot interface.

5. The method of claim 1, wherein saving the chatbot response and the corresponding metadata comprises saving the chatbot response and the corresponding metadata at a server system.

6. The method of claim 1, comprising:
saving a different set of saved chatbot responses for each of multiple different users, each set of saved chatbot responses comprising chatbot responses that the corresponding user selected to be saved from one or more conversations with one or more chatbots; and
for each of the multiple different users, providing, for display in a chatbot interface for the user, saved chatbot responses from the set of saved chatbot responses that the user had selected to be saved.

7. The method of claim 1, wherein the metadata for the saved chatbot response comprises at least one of:
a user prompt to which saved chatbot response responded;
one or more interpretations used by an AI/ML model to generate the saved chatbot response;
code or instructions for data retrieval generated by an AI/ML model or used to generate the saved chatbot response;
mappings of keywords or topics to data sets and data objects used to generate the saved chatbot response; and
topics or keywords associated with the prompt and response.

8. The method of claim 1, wherein the metadata for the saved chatbot response comprises information selected from multiple previous interactions with the chatbot.

9. The method of claim 1, wherein the metadata for the saved chatbot response comprises intermediate content from one of multiple interactions with an AI/ML model that were used to generate the saved chatbot response.

10. The method of claim 1, wherein the metadata for the saved chatbot response comprises a subset of content, from a conversation history that includes the saved chatbot response, that the one or more computers determine to be relevant to the saved chatbot response, including some or all of one or more previous prompts and responses before the user prompt to which the saved chatbot response responds.

11. The method of claim 1, wherein the metadata for the saved chatbot response comprises result data, obtained from a data processing system based on code or instructions generated based on the user prompt by an AI/ML model, that was used to generate the saved chatbot response.

12. The method of claim 1, wherein the metadata for the saved chatbot response comprises code or instructions for data retrieval or data processing to retrieve data from a data source, wherein the code or instructions is generated based on processing by the one or more AI/ML models used to generate the saved chatbot response.

13. A system comprising:
one or more computers; and
one or more non-transitory computer-readable media storing instructions that are operable, when executed by the one or more computers, to cause the one or more computers to perform operations comprising:
receiving, by the one or more computers, a user prompt from a user through a chatbot interface that is configured to receive input of user prompts and provide output of chatbot responses to the user prompts of a current conversation in a first region of the chatbot interface;
providing, by the one or more computers, a chatbot response to the user prompt through the chatbot interface, wherein the chatbot response is generated using one or more artificial intelligence and/or machine learning (AI/ML) models based on the user prompt;
providing, by the one or more computers, a control that is associated with the chatbot response on the chatbot interface and is selectable by the user to cause the chatbot response to be saved;
in response to user selection with the control, saving, by the one or more computers, the chatbot response and corresponding metadata that includes context information used by the one or more AI/ML models to generate the chatbot response; and
providing, by the one or more computers, data for a second region of the chatbot interface to display the saved chatbot response that the user selected to be saved, wherein the chatbot interface is configured to receive a subsequent user prompt associated with the saved chatbot response and to provide a subsequent chatbot response that answers the subsequent user prompt using the context information in the metadata corresponding to the saved chatbot response.

14. The system of claim 13, comprising:
displaying, in the second region, multiple saved chatbot responses that the user selected to be saved from different conversations or sessions of interaction with one or more chatbots, wherein each of the saved chatbot responses has corresponding saved metadata that includes context information used by the one or more AI/ML models to generate the chatbot response to which the saved metadata corresponds;
receiving input of an additional user prompt associated with a particular saved chatbot response of the multiple chatbot responses;
generating a chatbot response to the additional user prompt, including providing context information from the saved metadata corresponding to the particular saved chatbot response to the one or more AI/ML models; and
providing the chatbot response to the additional user prompt in the chatbot interface.

15. The system of claim 13, wherein the chatbot interface is configured to display saved chatbot responses for the user in the second region concurrently with display of user prompts and chatbot responses of the current conversation in the first region.

16. The system of claim 13, wherein the second region displays saved chatbot responses that the user selected to be saved from different chatbot conversations or different sessions of interaction with the chatbot interface.

17. The system of claim 13, wherein saving the chatbot response and the corresponding metadata comprises saving the chatbot response and the corresponding metadata at a server system.

18. The system of claim 13, comprising:
saving a different set of saved chatbot responses for each of multiple different users, each set of saved chatbot responses comprising chatbot responses that the corresponding user selected to be saved from one or more conversations with one or more chatbots; and
for each of the multiple different users, providing, for display in a chatbot interface for the user, saved chatbot responses from the set of saved chatbot responses that the user had selected to be saved.

19. The system of claim 13, wherein the metadata for the saved chatbot response comprises at least one of:
a user prompt to which saved chatbot response responded;
one or more interpretations used by an AI/ML model to generate the saved chatbot response;
code or instructions for data retrieval generated by an AI/ML model or used to generate the saved chatbot response;
mappings of keywords or topics to data sets and data objects used to generate the saved chatbot response; and
topics or keywords associated with the prompt and response.

20. One or more non-transitory computer-readable media storing instructions that are operable, when executed by one or more computers, to cause the one or more computers to perform operations comprising:
receiving, by the one or more computers, a user prompt from a user through a chatbot interface that is configured to receive input of user prompts and provide output of chatbot responses to the user prompts of a current conversation in a first region of the chatbot interface;
providing, by the one or more computers, a chatbot response to the user prompt through the chatbot interface, wherein the chatbot response is generated using one or more artificial intelligence and/or machine learning (AI/ML) models based on the user prompt;
providing, by the one or more computers, a control that is associated with the chatbot response on the chatbot interface and is selectable by the user to cause the chatbot response to be saved;
in response to user selection with the control, saving, by the one or more computers, the chatbot response and corresponding metadata that includes context information used by the one or more AI/ML models to generate the chatbot response; and
providing, by the one or more computers, data for a second region of the chatbot interface to display the saved chatbot response that the user selected to be saved, wherein the chatbot interface is configured to receive a subsequent user prompt associated with the saved chatbot response and to provide a subsequent chatbot response that answers the subsequent user prompt using the context information in the metadata corresponding to the saved chatbot response.
